(19) United States
(12) Patent Application Publication
(10) Pub. No.: US 2026/0067190 A1
(43) Pub. Date: Mar. 5, 2026

(54) MANAGING COMMUNICATIONS AND OUT-OF-COVERAGE SCENARIOS IN A NON-TERRESTRIAL NETWORK

(71) Applicant: Google LLC, MOUNTAIN VIEW, CA (US)

(72) Inventors: Chih-Hsiang WU, Taoyuan City (TW); Ming-Hung TAO, Taoyuan City (TW)

(21) Appl. No.: 19/100,877

(22) PCT Filed: Aug. 11, 2023
(86) PCT No.: PCT/US2023/030071

§ 371 Date: Feb. 3, 2025

Related U.S. Application Data
(60) Provisional application No. 63/397,725, filed on Aug. 12, 2022.

(51) Int. Cl. H04L 43/0811; H04W 76/19; H04W 76/28; H04W 84/06

(52) U.S. Cl. CPC H04L 43/0811; H04W 76/19; H04W 76/28; H04W 84/06

(57) ABSTRACT

A UE and a RAN node that communicate via an NTN operate to avoid wasting radio communication resources and UE's battery power during an out of NTN coverage. Upon determining that the UE is out of NTN coverage, the UE refrains from seeking to reconnect until determining the UE is in the NTN coverage. Upon detecting an upcoming out of coverage period, the RAN node sends an RRC release message to the UE. The RRC release message may include a timer value exceeding an estimated duration of the upcoming out of coverage, the UE waiting a time interval corresponding to the timer value before attempting to reconnect.

### FIELD OF THE DISCLOSURE

This disclosure relates generally to wireless communication systems, and particularly to communications that involve non-terrestrial network (NTN) elements such as satellites.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Generally speaking, a base station operating a cellular radio access network (RAN) communicates with a user equipment (UE) using a certain radio access technology (RAT) and multiple layers of a protocol stack. For example, the physical layer (PHY) of a RAT provides transport channels to the Medium Access Control (MAC) sublayer, which in turn provides logical channels to the Radio Link Control (RLC) sublayer, and the RLC sublayer in turn provides data transfer services to the Packet Data Convergence Protocol (PDCP) sublayer. The Radio Resource Control (RRC) sublayer is disposed above the PDCP sublayer.

The RRC sublayer specifies the RRC_IDLE state, in which a UE does not have an active radio connection with a base station and does not store a UE access stratum (AS) context; the RRC_CONNECTED state, in which the UE has an active radio connection with the base station; and the RRC_INACTIVE to allow a UE to more quickly transition back to the RRC_CONNECTED state due to Radio Access Network (RAN)-level base station coordination and RAN-paging procedures. Depending on different implementations or scenarios, the base station can configure Small Data Transmission (SDT) for the UE operating in the RRC_INACTIVE to transmit one or more small packets.

The 5G technology relies primarily on legacy terrestrial networks. However, the 3rd Generation Partnership Project (3GPP) organization has proposed to extend 5G communications to non-terrestrial networks (NTNs) with 5G new radio (NR) technologies, or with the Long-Term-Evolution (LTE) technologies tailored for the Narrowband Internet-of-Thing (NB-IoT) or the enhanced Machine Type Communication (eMTC) scenarios. In an NTN, an RF transceiver is mounted on a satellite, an unmanned aircraft system (UAS), also called drone, balloon, plane, or another suitable apparatus. For simplicity, the discussion below refers to all such apparatus as satellites. In addition to satellites, an NTN can include the sat-gateways that connect the Non-Terrestrial Network to a public data network, feeder links between sat-gateways and satellites, service links between satellites and UEs, and inter-satellite links (ISL) when satellites form constellations.

A satellite can belong to one of several types based on altitude, orbit, and beam footprint size. The types include Low-Earth Orbit (LEO) satellite, Medium-Earth Orbit (MEO) satellite, Geostationary Earth Orbit (GEO) satellite, UAS platform (including High Altitude Platform Station, HAPS), and High Elliptical Orbit (HEO) satellite. GEO satellites are also known as the Geosynchronous Orbit (GSO) satellites, and LEO/MEO satellites are also known as the non-GSO (NGSO) satellites.

A GSO satellite is stationary relative to the Earth's surface and is able to communicate continuously with same one or several sat-gateways within a satellite targeted coverage area (e.g., a region or even a continent). A non-GSO satellite is changing in time its location relative to the Earth's surface, and, therefore, at different times, is able to communicate only temporarily with one or several serving sat-gateways. An NTN is designed to ensure service and feeder link continuity between successive serving sat-gateways, with sufficient time duration to proceed with mobility anchoring and hand-over.

A satellite can support a transparent or a regenerative (with on board processing) payload, and typically generates several beams for a given service area bounded by the field of view. The footprints of the beams typically have an elliptic shape and depend on the on-board antenna configuration and the elevation angle. For a transparent payload implementation, a satellite can apply RF filtering and frequency conversion and amplification, and not change the waveform signal. For a regenerative payload implementation, a satellite can apply RF filtering, frequency conversion and amplification, demodulation and decoding, routing, and coding/modulation. This approach is effectively equivalent to implementing most of the functions of a base station, e.g., a gNB.

NB-IoT and eMTC technologies are expected to be particularly suitable for IoT devices operating in remote areas with limited or no terrestrial connectivity. Such IoT devices can be used in a variety of industries including for example transportation (maritime, road, rail, air) and logistics; solar, oil, and gas harvesting; utilities; farming; environmental monitoring; and mining. However, to ensure the required IoT connectivity, deployment of these technologies requires satellite connectivity to provide coverage beyond terrestrial deployments. Satellite NB-IoT or eMTC is defined in a complementary manner to terrestrial deployments.

Compared to the terrestrial network (TN) communication, the NTN communication has a very long latency caused by the service link (i.e., the link between the UE and satellite) and feeder link (i.e., the link between the satellite and base station). When the UE in an idle state (e.g., the UE operates in the RRC_IDLE state without a UE AS context) initiates data transmission in an NTN, the UE has to perform several procedures with a base station and a core network to communicate application data with an application server. These procedures can include a service request procedure, RRC connection establishment procedure, non-access stratum (NAS) authentication procedure, NAS security command procedure, RRC security command procedure, RRC reconfiguration procedures, etc. Messages are exchanged between the UE and base station or core network, which consumes significant time. When the base station detects data inactivity for the UE operating in the RRC_CONNECTED state, the base station can suspend the active radio connection with the UE by transitioning the UE to the RRC_INACTIVE state or transitioning the UE to the RRC_IDLE state with a suspended RRC connection (i.e., the UE in the RRC_IDLE stores a UE AS context). When the UE has application data to send, the UE can perform an RRC connection resume procedure (i.e., a single RRC procedure) with the base station to resume the suspended active radio connection and transition to the RRC_CONNECTED state. The UE communicates the application data immediately upon completing the RRC connection resume procedure.

When the UE in the RRC_INACTIVE state or the RRC_IDLE state with a suspended radio connection initiates an RRC connection resume procedure for uplink data transmission or periodic RAN notification (RNA) update, the UE starts a timer (e.g., T319 or T300). If the UE Successfully completes the RRC connection resume procedure with the base station, the UE stops the timer. However, if the timer expires before the UE completes the RRC connection resume procedure, the UE releases the UE AS context and transitions to the RRC_IDLE. In an NTN, as a satellite moves on a specified orbit, for example in case of a NGSO satellite, the satellite beam(s) coverage area may move and cover different portions of a geographical area due to the orbital movement of the satellite. As a consequence, the UE located in the concerned geographical area may experience a situation of discontinuous coverage, due to, e.g., a sparse satellite constellation deployment. In such a situation, the UE in the NTN can lose coverage for a long period (e.g., tens of minutes to hours) due to the discontinuous coverage. In some cases, the UE in the NTN can initiate the RRC connection resume procedure while the UE is out of coverage due to the time-discontinuous coverage. The RRC connection resume procedure triggers a cell search. As the UE is out of coverage due to the discontinuous coverage, it is not possible that the UE can find a suitable cell in the NTN. Thus, the cell search wastes the UE's battery power. Moreover, the timer expires because the UE fails the RRC connection resume procedures. Upon expiry of the timer, the UE releases the UE AS context and transitions to the RRC_IDLE, which will cause a long delay in transmitting data the next time the UE in coverage establishes a connection because the UE has to perform the several procedures.

While the UE communicates with the base station via a satellite in an NTN, the UE can detect radio link failure on the link with the satellite due to out of coverage caused by the discontinuous coverage. In accordance with section 5.3.7 in 3GPP specifications 38.331 or 36.331, the UE initiates an RRC connection reestablishment procedure to recover from the radio link failure situation. Upon initiating the RRC connection reestablishment procedure, the UE starts a timer (i.e., T311) with a timer value and performs a cell search to find a suitable cell. If the UE successfully finds a suitable cell, the UE stops the timer. Otherwise, the UE continues to search for a suitable cell. As the UE is out of coverage due to the discontinuous coverage, it is not possible that the UE can find a suitable cell. Thus, the cell search wastes the UE's battery power.

### SUMMARY

A UE and a RAN node communicating via an NTN operate to avoid wasting radio communication resources and UE power during out of NTN coverage. Upon determining that the UE is out of NTN coverage, the UE refrains from seeking to reconnect to the NTN until the UE is again in the NTN coverage. This UE behavior saves UE's battery power. The UE may transition to an idle state until determining it is back in the NTN coverage. A RAN node detecting an upcoming out of coverage period for a UE connected to the RAN node via an NTN, frees the radio communication resources reserved for the UE-NE communications by sending an RRC release message to the UE. The RRC release message may include a timer value exceeding an estimated duration of the upcoming out of coverage, and the UE waits a time interval corresponding to the timer value before attempting to reconnect.

### BRIEF DESCRIPTION OF THE DRAWINGS

The accompanying drawings, which are incorporated in and constitute a part of the specification, illustrate one or more embodiments and, together with the detailed description, explain these embodiments.

FIG. 1A is a block diagram of an example wireless communication system in which a user device and a base station perform methods according to various embodiments.

FIG. 1B is a block diagram of an example base station in which a centralized unit (CU) and a distributed unit (DU) operate in the system of FIG. 1A.

FIG. 2A is a block diagram of an example protocol stack according to which the UE of FIG. 1A communicates with base stations.

FIG. 2B is a block diagram of an example protocol stack according to which the UE of FIG. 1A communicates with a CU and a DU.

FIG. 3A is a block diagram of an example NTN node with transparent payload implementation.

FIG. 3B is a block diagram of an example NTN node with transparent payload implementation, in which a base station connects to multiple satellites via the same sat-gateway.

FIG. 4A illustrates an exemplary user plane protocol stack for use with the architecture of FIG. 3A.

FIG. 4B illustrates an exemplary control plane protocol stack for use with the architecture of FIG. 3A.

FIG. 5 illustrates an example scenario in which a UE has satellite coverage during certain time periods separated by intervals of non-coverage.

FIG. 6 is an example scenario according to which a UE-NE connection is suspended before the out of NTN coverage for the UE.

FIGS. 7A, 7B, and 7C are example scenarios according to which a radio link failure occurs before the out of NTN coverage for the UE.

FIGS. 8A, 8B, 8C, and 8D are example scenarios according to which the UE and/or the NE detect an upcoming out of NTN coverage for the UE.

FIGS. 9A, 9B, and 9C are flowcharts of UE methods in which the UE-NE connection is suspended before the out of NTN coverage, according to various embodiments.

FIGS. 10A, 10B, and 10C are flowcharts of UE methods in which a radio link failure occurs before the out of NTN coverage, according to various embodiments.

FIG. 11 is a flowchart of a UE method in which the UE terminates its attempt to reestablish connection with the NTN when detecting that it is out of NTN coverage, according to an embodiment.

FIG. 12 is a flowchart performed by a RAN node connected to a UE via an NTN in view of an upcoming out of NTN coverage, according to an embodiment.

### DETAILED DESCRIPTION OF THE DRAWINGS

As discussed in more detail below, a user equipment (UE) and/or a network node of a radio access network (RAN) can use the techniques of this disclosure for managing early data communication and transitioning a UE between states of a protocol for controlling radio resources between the UE and the RAN.

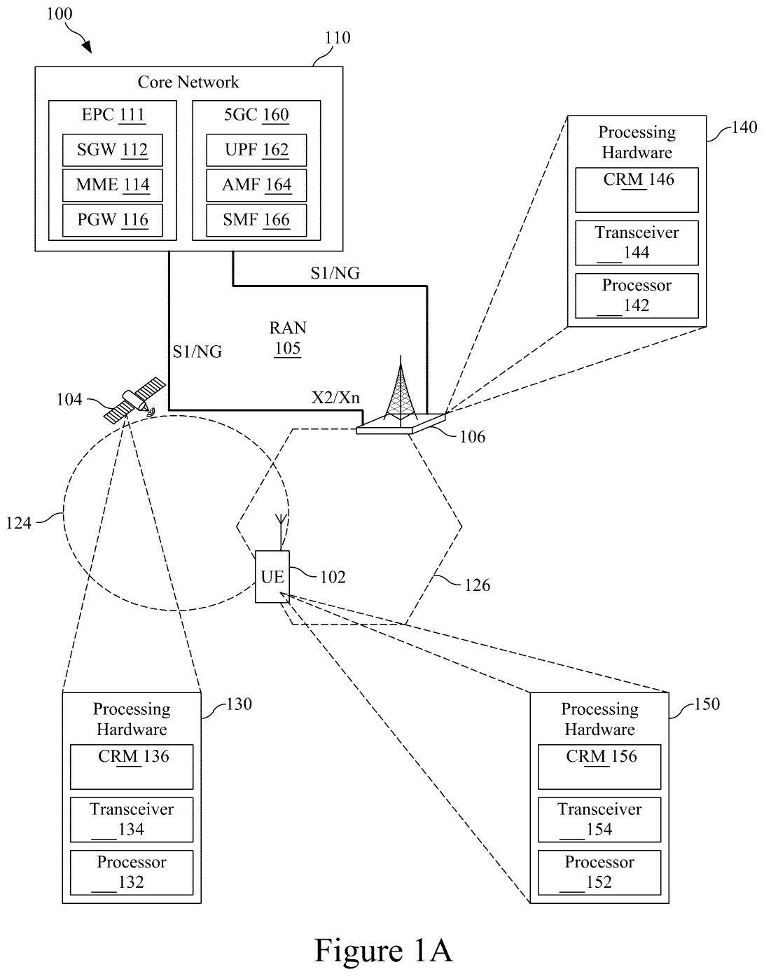

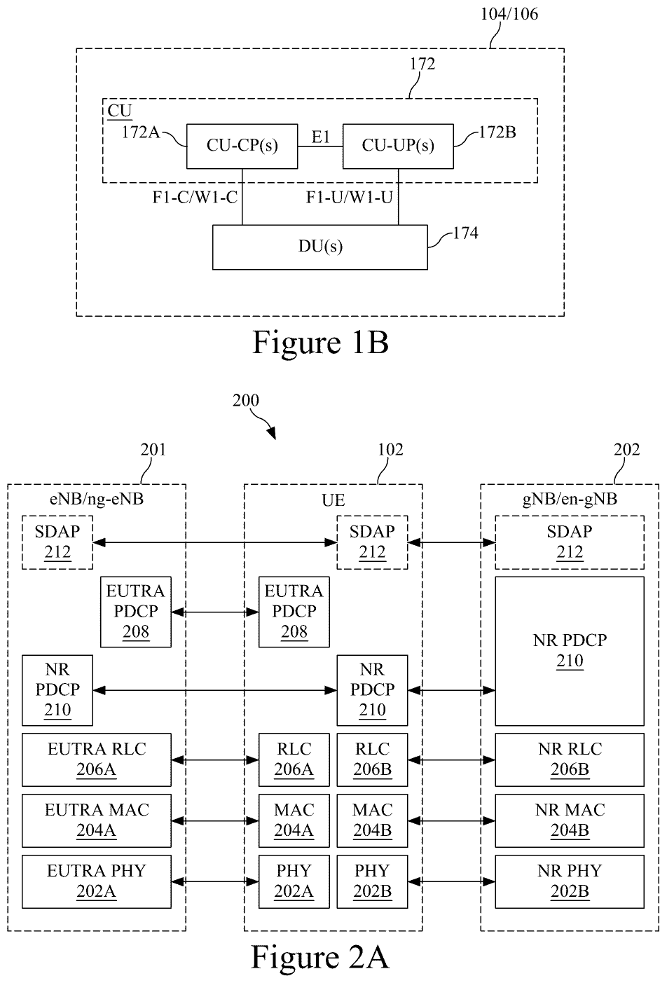

Referring first to FIG. 1A, an example wireless communication system 100 includes a UE 102, a base station (BS) 104, a base station 106, and a core network (CN) 110. The base stations 104 and 106 can operate in a RAN 105 connected to the core network (CN) 110. The CN 110 can be implemented as an evolved packet core (EPC) 111 or a fifth generation (5G) core (5GC) 160, for example. The CN 110 can also be implemented as a sixth generation (6G) core in another example.

The base station 104 covers a cell 124, and the base station 106 covers a cell 126. If the base station 104 is a gNB, the cell 124 is an NR cell. If the base station 104 is an ng-eNB or eNB, the cell 124 is an evolved universal terrestrial radio access (E-UTRA) cell. Similarly, if the base station 106 is a gNB, the cell 126 is an NR cell, and if the base station 106 is an ng-eNB or eNB, the cell 126 is an E-UTRA cell. The cells 124 and 126 can be in the same Radio Access Network Notification Areas (RNA) or different RNAs. In general, the RAN 105 can include any number of base stations, and each of the base stations can cover one, two, three, or any other suitable number of cells. The UE 102 can support at least a 5G NR (or simply, “NR”) or E-UTRA air interface to communicate with the base stations 104 and 106. Each of the base stations 104, 106 can connect to the CN 110 via an interface (e.g., S1 or NG interface). The base stations 104 and 106 also can be interconnected via an interface (e.g., X2 or Xn interface) for interconnecting NG RAN nodes.

Among other components, the EPC 111 can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management Function (AMF) 164, and/or Session Management Function (SMF) 166. Generally speaking, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions.

As illustrated in FIG. 1A, the base station 104 supports a cell 124, and the base station 106 supports a cell 126. Note that cell 124 has a shape corresponding to the footprint of the satellite beams, which unlike cell 126, can project on different areas at different times. The cells 124 and 126 can partially overlap, so that the UE 102 can select, reselect, or hand over from one of the cells 124 and 126 to the other. To directly exchange messages or information, the base station 104 and base station 106 can support an X2 or Xn interface. In general, the CN 110 can connect to any suitable number of base stations supporting NR cells and/or EUTRA cells.

As discussed in detail below, the UE 102 and/or the RAN 105 may utilize the techniques of this disclosure when the radio connection between the UE 102 and the RAN 105 is suspended, e.g., when the UE 102 operates in an inactive or idle state of the protocol for controlling radio resources between the UE 102 and the RAN 105. For clarity, the examples below refer to the RRC_INACTIVE or RRC_IDLE state of the RRC protocol.

The base station 104 is equipped with processing hardware 130 that can include one or more general-purpose processors (e.g., CPUs) and a non-transitory computer-readable memory (CRM) storing instructions that the one or more general-purpose processors execute. Additionally or alternatively, the processing hardware 130 can include special-purpose processing units. According to an embodiment illustrated in FIG. 1A, the processing hardware 130 includes a processor 132 to process data that the base station 104 will transmit in the downlink direction, or data received by the base station 104 in the uplink direction. The processing hardware 130 also includes a transceiver 134 configured to transmit data in the downlink direction and to receive data in the uplink direction. The processing hardware 130 further includes CRM 136 storing executable codes for the processor 132 to perform methods according to embodiments described in this section. The base station 106 can include generally similar components. In particular, components 140, 142, 144, and 146 of the base station 106 can be similar to the components 130, 132, 134, and 136 respectively.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes a processor 152 to process data that the UE 102 will transmit in the uplink direction, or process data received by UE 102 in the downlink direction. The processing hardware 150 can also include a transceiver 156 configured to transmit data in the downlink direction and to receive data in the uplink direction.

FIG. 1B depicts an example distributed or disaggregated implementation of any one or more of the base stations 104, 106. In this implementation, the base station 104, 106 includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include a PDCP controller, an RRC controller and/or an RRC inactive controller. In some implementations, the CU 172 can include a radio link control (RLC) controller configured to manage or control one or more RLC operations or procedures. In further implementations, the CU 172 does not include an RLC controller.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a MAC controller configured to manage or control one or more MAC operations or procedures (e.g., a random access procedure), and/or an RLC controller configured to manage or control one or more RLC operations or procedures. The process hardware can also include a physical layer controller configured to manage or control one or more physical layer operations or procedures.

In some embodiments, the RAN 105 supports Integrated Access and Backhaul (IAB) functionality. In some implementations, the DU 174 operates as an IAB-node, and the CU 172 operates as an IAB-donor. In some embodiments, the RAN 105 supports Non-Terrestrial Network (NTN) functionality.

In some implementations, the CU 172 can include a logical node CU-CP 172A that hosts the control plane part of the PDCP protocol of the CU 172. The CU 172 can also include logical node(s) CU-UP 172B that hosts the user plane part of the PDCP protocol and/or Service Data Adaptation Protocol (SDAP) protocol of the CU 172. The CU-CP 172A can transmit control information (e.g., RRC messages, F1 application protocol messages), and the CU-UP 172B can transmit the data packets (e.g., SDAP PDUs or Internet Protocol packets).

The CU-CP 172A can be connected to multiple CU-UP 172B through the E1 interface. The CU-CP 172A selects the appropriate CU-UP 172B for the requested services for the UE 102. In some implementations, a single CU-UP 172B can connect to multiple CU-CP 172A through the E1 interface. The CU-CP 172A can connect to one or more DU 174s through an F1-C interface. The CU-UP 172B can connect to one or more DU 174 through the F1-U interface under the control of the same CU-CP 172A. In some implementations, one DU 174 can connect to multiple CU-UP 172B under the control of the same CU-CP 172A. In such implementations, the connectivity between a CU-UP 172B and a DU 174 is established by the CU-CP 172A using Bearer Context Management functions.

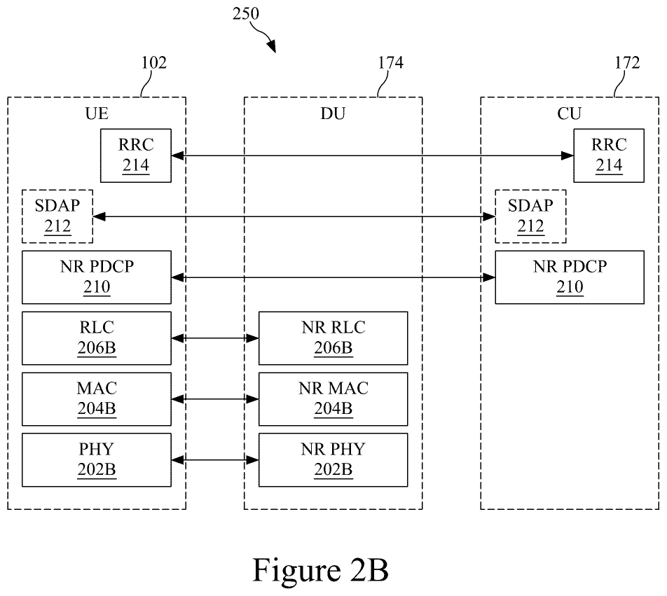

FIG. 2A illustrates, in a simplified manner, an example protocol stack 200 according to which the UE 102 can communicate with an eNB/ng-eNB 201 or a gNB 202 (e.g., one or more of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to an EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to Service Data Adaptation Protocol (SDAP) 212 or a radio resource control (RRC) sublayer (not shown in FIG. 2A). The UE 102, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) or RRC sublayer (not shown in FIG. 2A) to exchange RRC messages or non-access-stratum (NAS) messages, for example. On a user plane, the EUTRA PDCP sublayer 208 and the NR PDCP sublayer 210 can provide Data Radio Bearers (DRBs) to support data exchange. Data exchanged on the NR PDCP sublayer 210 can be SDAP PDUs, Internet Protocol (IP) packets or Ethernet packets.

FIG. 2B illustrates, in a simplified manner, an example protocol stack 250, which the UE 102 can communicate with a DU (e.g., DU 174) and a CU (e.g., CU 172). The radio protocol stack 200 is functionally split as shown by the radio protocol stack 250 in FIG. 2B. The CU at any of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

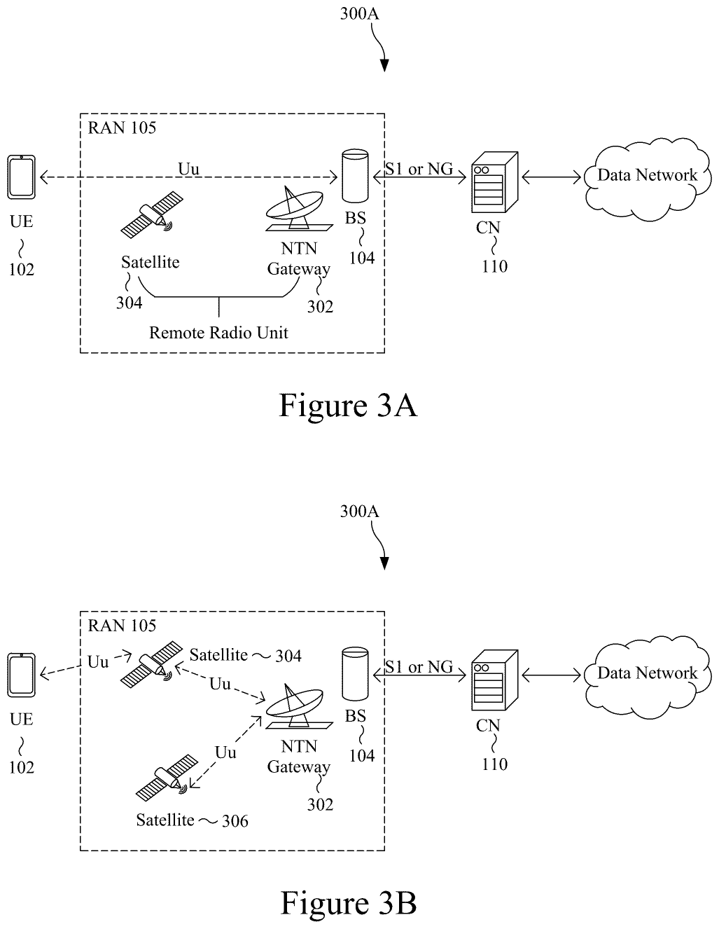

FIG. 3A illustrates a certain type of NTN deployment referred to as transparent payload architecture, which involves a satellite gateway 302 and a “transparent” satellite 304 for extending the range of the Uu interface. In one implementation, the satellite 304 implements a frequency conversion and a Radio Frequency (RF) amplifier in both the uplink and downlink directions. With that being said, the satellite function is similar to that of an analogue RF repeater. As a result, the satellite 304 repeats the Uu radio interface from the feeder link (between the NTN gateway and the satellite) to the service link (between the satellite and the UE) in the downlink direction and vice versa in the uplink direction. The Satellite Radio Interface (SRI) on the feeder link is the Uu, and the NTN gateway 302 supports all necessary functions to forward the signal of the Uu interface. The NTN gateway 302 can be placed at the same site as the base station (e.g., eNB, gNB) 104 location, or be connected to the base station 104 at a distance via a wired link. It is also possible to connect more than one NTN gateway to a base station. Different transparent satellites may be connected to the same base station on the ground, via the same NTN gateway, or via different NTN gateways. FIG. 3B illustrates the case where two different satellites (304 and 306) are connected to the same base station 104 via the same NTN gateway 302, and these two satellites (304 and 306) are covering the Earth surface using two different Physical Cell IDs (PCIs).

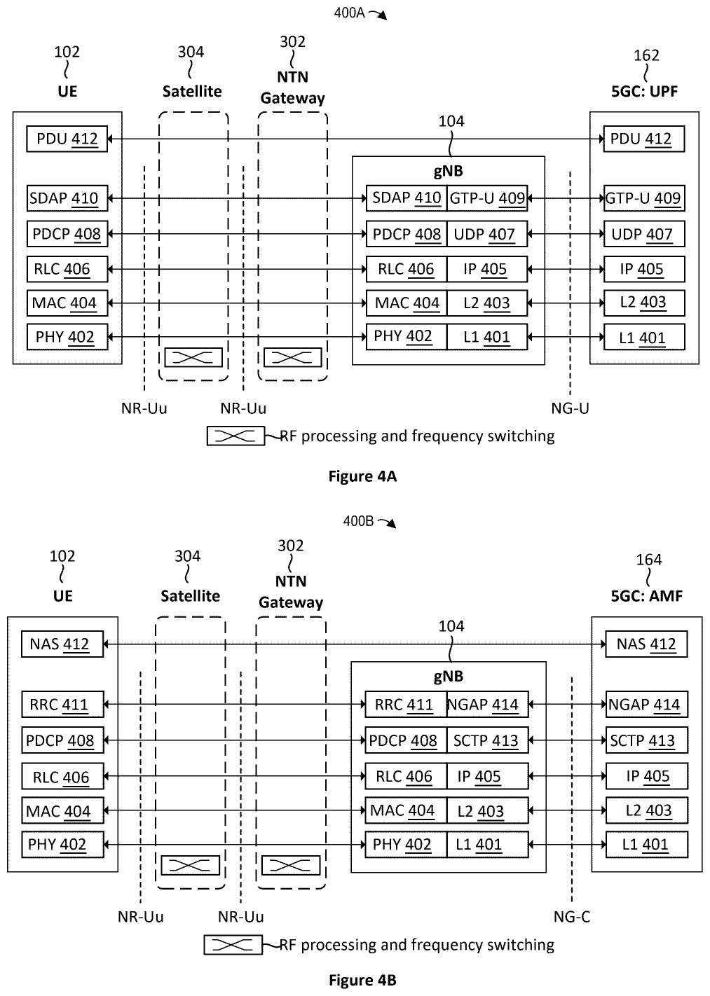

The NTN user plane protocol stack, UPPS, involving the UE 102, the satellite 304, the NTN gateway 302, the NR base station (i.e., gNB) 104, and the UPF 162 is illustrated in FIG. 4A. The diagram of the NTN UPPS is similar to that of the terrestrial network, TN, with the addition of two new nodes, the satellite 304 and the NTN gateway 302, being placed in the middle of the NR-Uu interface. The UE-to/from-gNB communications employ physical layer 402, MAC layer 404 and Radio Link Control, RLC, layer 406. Further, the UE-to/from-gNB communications employ a packet Data Convergence Protocol, PDCP, 408 and a Service Data Adaptation Protocol, SDAP, 410. The gNB-to/from-UPF communications employ an L1 layer 401 (i.e., 5G Physical Layer), an L2 layer 402 (i.e., 5G Data Link Layer) and an Internet Protocol, IP, 405. Further, the gNB-to/from-UPF communications employ a User Datagram Protocol, UDP, 407 and a GPRS Tunnelling Protocol, for carrying user data, GTP-U 409 (here acronym GPRS stands for General Packet Radio Services).

The NTN control plane protocol stack, CPPS, illustrated in FIG. 4B is also similar to that of the TN. The differences between the UPPS in FIG. 4A and the CPPS in FIG. 4B are now discussed. Instead of SDAP 410 in UPPS, the CPPS includes an RRC layer 411. Further, the UDP 407 and the NGAP 409 are replaced by the Stream Control Transmission Protocol, SCTP, 413, and the Next Generation Application Protocol, NGAP, 414. Descriptions of these protocols and communication layers can be found in contemporaneous 3GPP technical specifications.

In terms of the satellite moving pattern, there are three types of service links that are supported in NTN:
Earth-fixed: provisioned by beam(s) continuously covering the same geographical areas all the time (e.g., the case of GEO/GSO satellites)
Quasi-Earth-fixed: provisioned by beam(s) covering one geographic area for a limited period and a different geographic area during another period (e.g., the case of LEO/MEO satellites capable of using steerable beams)
Earth-moving: provisioned by beam(s) whose coverage area slides over the Earth surface (e.g., the case of LEO/MEO satellites using fixed or non-steerable beams).

With LEO/MEO satellites, the eNB can provide either quasi-Earth-fixed cell coverage or Earth-moving cell coverage. With GEO satellites, the eNB can provide Earth fixed cell coverage.

Although the transparent payload architecture illustrated in FIGS. 3A/3B is the current focus of the 3GPP development, the regenerative payload architecture that installs the eNB functions on the satellite is also a possible NTN deployment in the future. In such an architecture, the Uu only exists between the satellite and the UE. In general, the techniques of this disclosure can apply to the transparent payload architecture as well as the regenerative payload architecture.

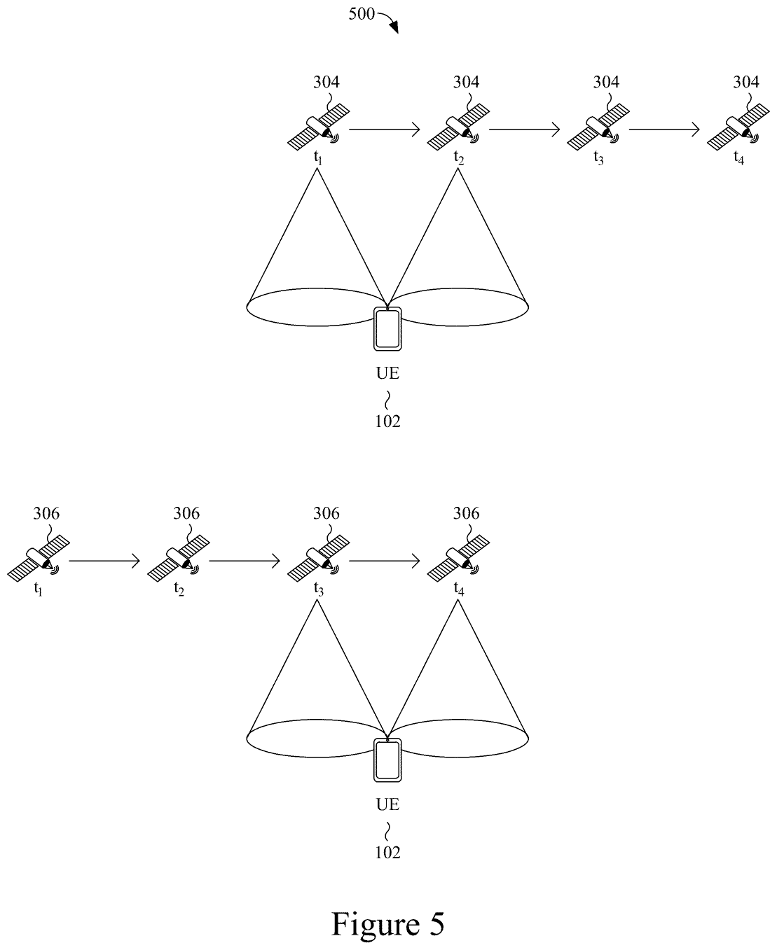

FIG. 5 illustrates an example scenario 500 in which the UE 102 located in the concerned geographical area may experience a situation of discontinuous coverage, due to e.g., a sparse satellites constellation deployment. In the scenario, the UE 102 is served by the LEO satellite 304 from t1 to t2 and served by another LEO satellite 306 from t3 to t4. In the period between t2 to t3, the UE 102 is not served by any satellite or any terrestrial base station and therefore is out of coverage. Typically, when a UE loses coverage by a serving cell, the UE starts searching for other cells and then camps on a suitable cell. However, in the example illustrated in FIG. 5, even if the UE 102 starts searching for other cells immediately after t2, the UE 102 cannot find a cell. The cell search lasts for a long time as the time period between t2 to t3 can vary from tens of minutes to hours. Therefore, the cell search causes extra, unnecessary power consumption in the UE 102. To reduce power consumption at the UE in particular NTN scenarios such as the one depicted in FIG. 5, the UE may not be required to perform the cell search and can deactivate the Access Stratum (AS) functions during the period when the UE is not within the area of coverage of a satellite. In some implementations, the UE has knowledge of when the UE will be outside the area of coverage, and when the UE will be within an area of coverage again, in order to activate its cell search or AS functions again right before the UE falls into the coverage of another NTN cell. For example, the ephemeris information broadcasted in the system information provides the constellation and trajectory/movement information of the serving and the neighboring satellites, which helps UE to predict/estimate when it will be within and when it will be outside the NTN coverage. In addition to the ephemeris information, the UE may use other information to estimate/predict coverage of an NTN cell more precisely.

In some scenarios, the UE 102 in a connected state (e.g., RRC_CONNECTED state) communicates with a RAN via the satellite 304, and then detects radio link failure on the service link with the satellite 304 after the UE 102 is out of coverage of the satellite 304, e.g., in the period between t2 to t3. In response to the radio link failure, the UE 102 initiates an RRC connection reestablishment procedure, e.g., in accordance with 3GPP specification 38.331.

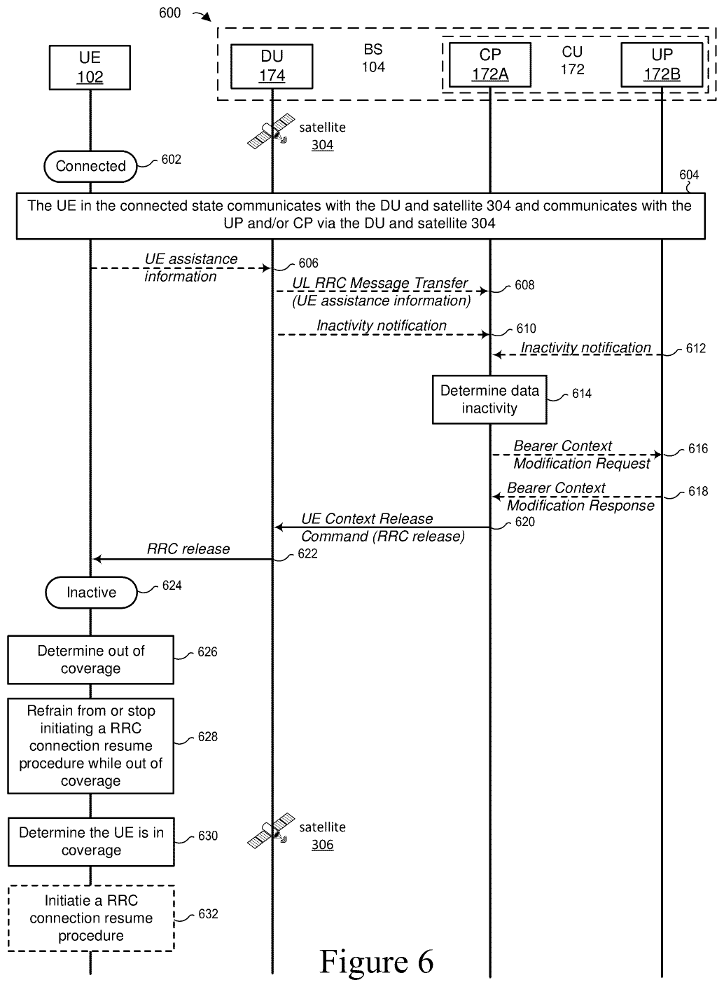

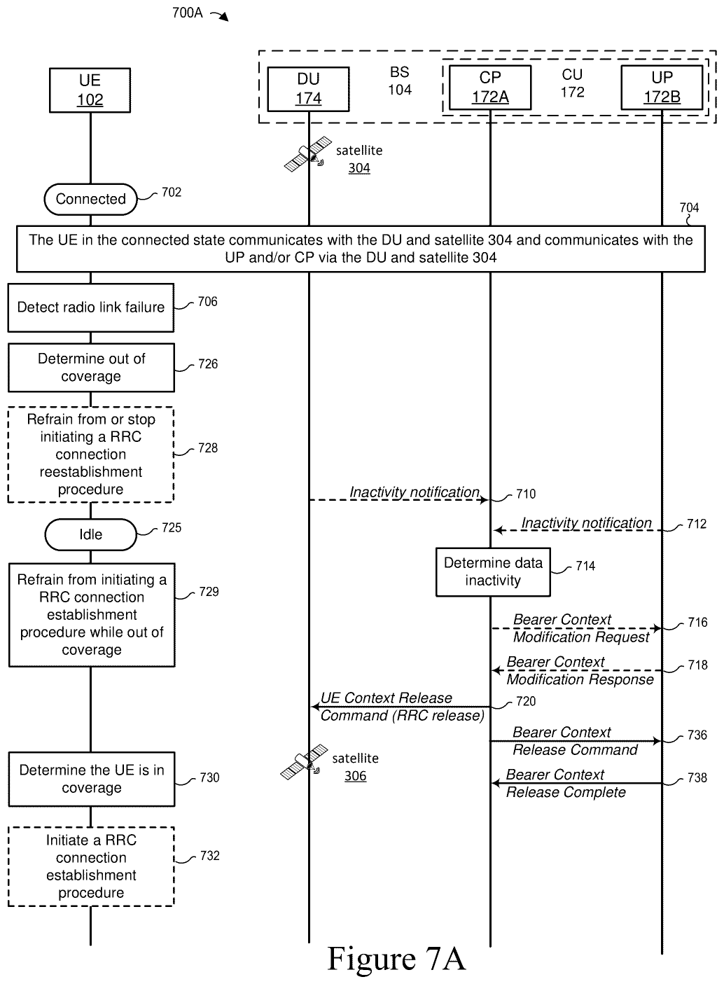

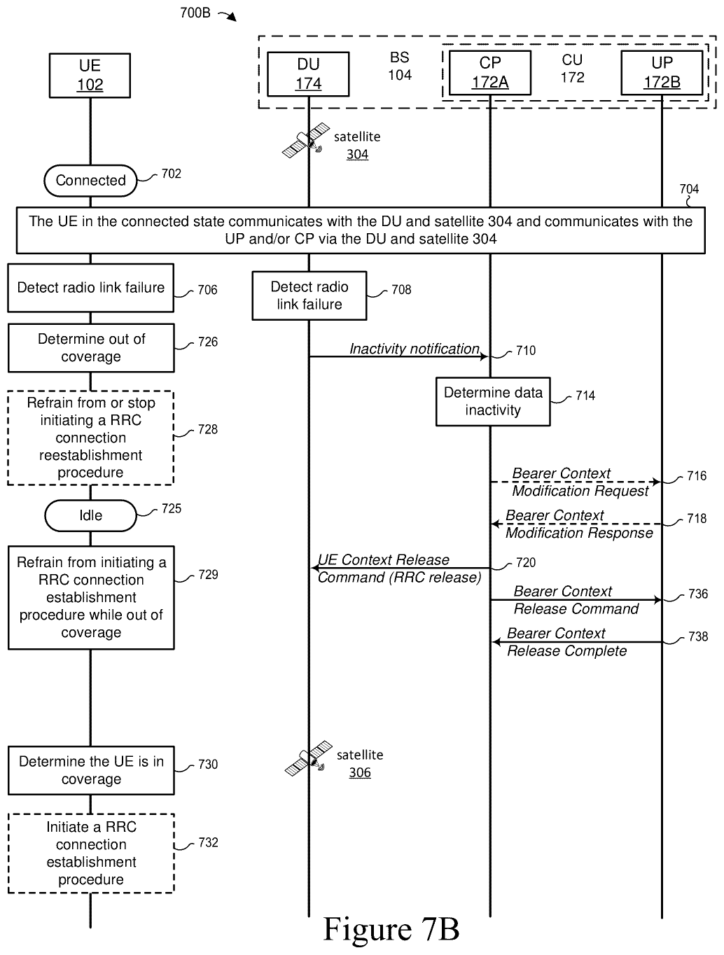

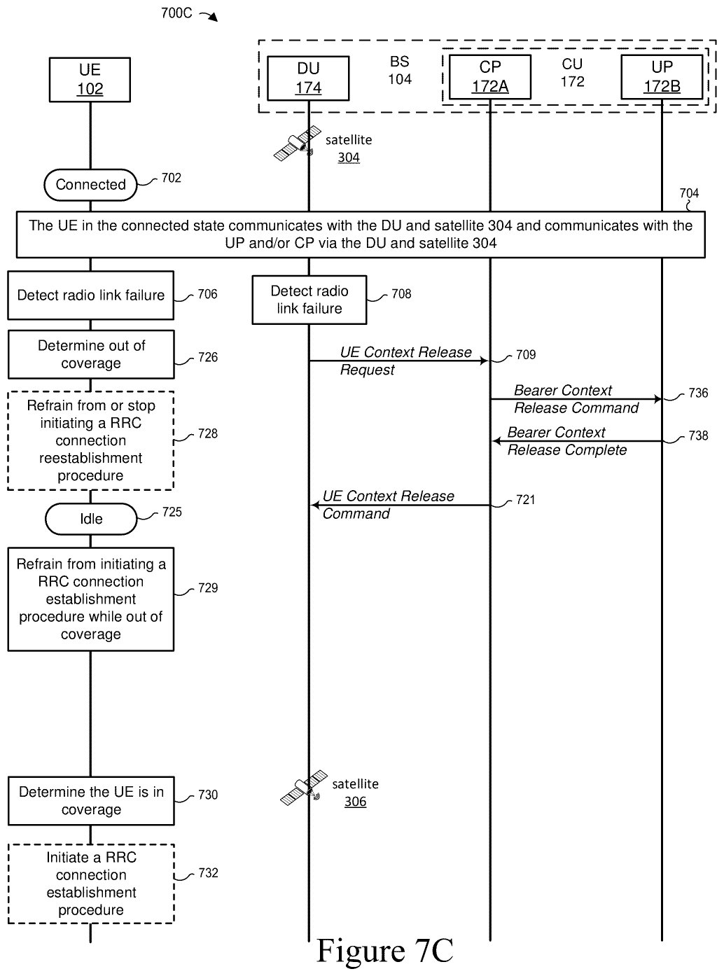

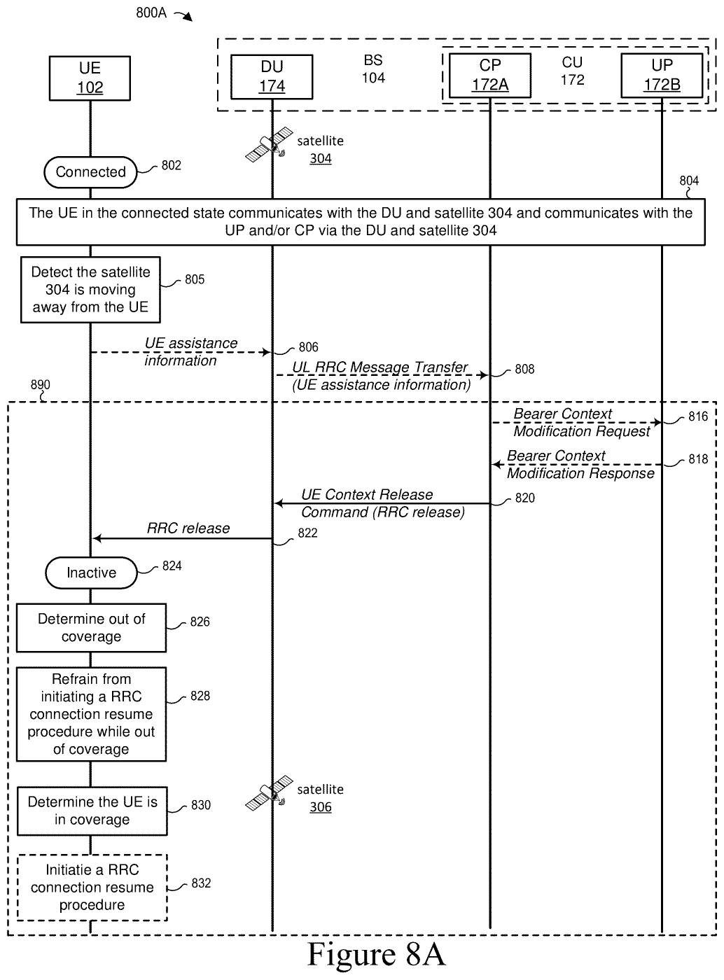

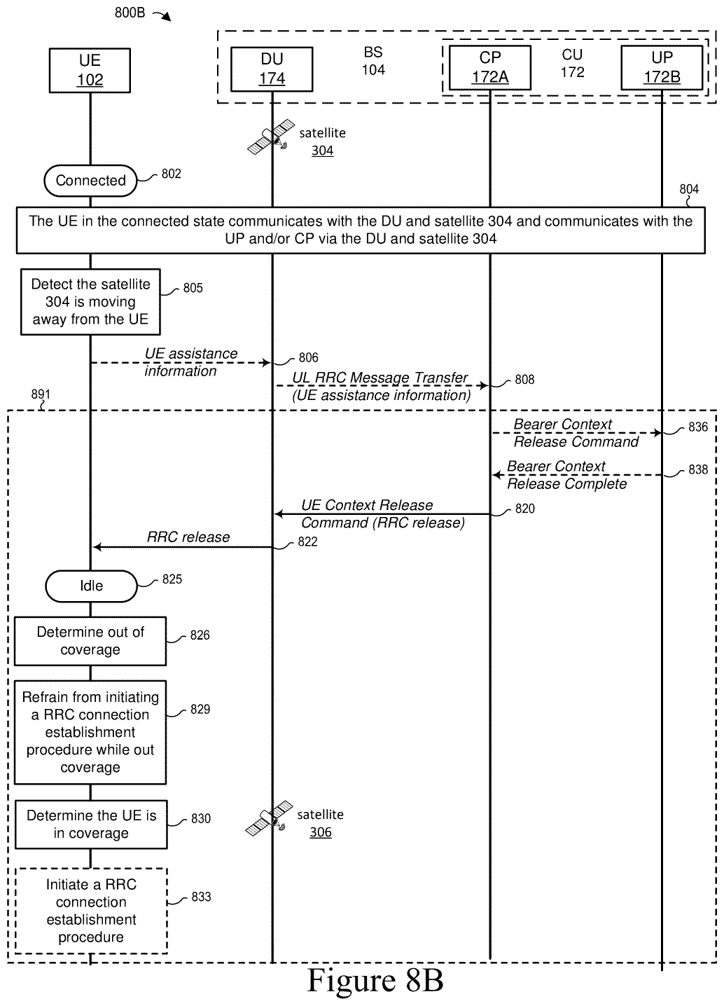

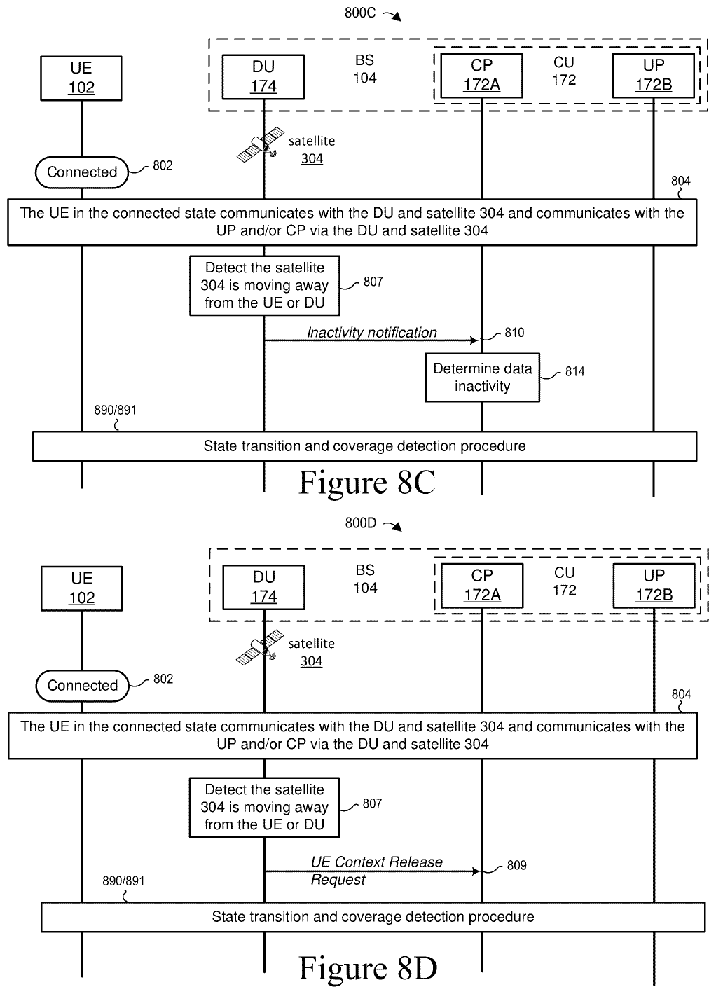

Next, several example scenarios that involve several components of FIG. 1A and relate to detecting out of coverage in an inactive or connected state are discussed next with reference to FIGS. 6-8F. Generally speaking, similar events in FIGS. 6-8F are labeled with similar reference numbers (e.g., event 604 in FIG. 6 is similar to event 704 in FIGS. 7A-7D, event 804 in FIGS. 8A-8E), with differences discussed below where appropriate. With the exception of the differences shown in the figures and discussed below, any of the alternative implementations discussed with respect to a particular event (e.g., for messaging and processing) may apply to events labeled with similar reference numbers in other figures and also to both integrated and distributed base stations.

Referring first to FIG. 6, an example scenario 600 in which the base station 104, includes a CU 172, a DU 174, a satellite 304 and a satellite 306, and suspends a radio connection between the UE 102 and base station 104. In this scenario, the UE 102 initially operates in a connected state 602 and communicates 604 with the DU 174 via the satellite 304, e.g., by using a DU configuration, and communicates 604 with the CU-CP 172A and/or CU-UP 172B via the DU 174 and satellite 304, e.g., by using a CU configuration.

In some implementations, the DU configuration includes configuration parameters related to operations of RLC, MAC, and/or PHY protocol layers (e.g., RLC 206B, MAC 204B and/or PHY 202B), that the UE 102 and DU 174 use to communicate with one another while the UE 102 operates in the connected state. In some implementations, the DU configuration can be a CellGroupConfig IE or include the configuration parameters include configuration parameters in a CellGroupConfig IE. The CellGroupConfig IE is defined in 3GPP specification 38.331. In other implementations, the DU configuration can include configuration parameters in a RadioResourceConfigDedicated-NB-r13 or RadioResourceConfigDedicated IE defined in 3GPP specification 36.331.

In some implementations, the CU configuration includes configuration parameters such as PDCP configuration parameters, radio bearer configuration(s) (e.g., SRB and/or DRB configuration(s), and/or measurement configuration(s). In one implementation, the CU configuration includes a RadioBearerConfig IE and/or MeasConfig IE(s) defined in 3GPP specification 38.331. In another implementation, the CU configuration includes configuration parameters in the RadioBearerConfig IE and/or MeasConfig IE. In yet another implementation, the CU configuration includes SRB-ToAddMod IE(s), DRB-ToAddMod IE(s) and/or MeasConfig IE(s) in the RadioResourceConfigDedicated-NB-r13 or RadioResourceConfigDedicatedIE.

While the UE 102 communicates with the base station 104, the CU-CP 172A can determine 614 to transition the UE 102 to suspend a radio connection between the UE 102 the base station 104, based on data inactivity of the UE 102 (i.e., the UE 102 in the connected state has no data activity with the base station 104). In some implementations, the base station 104 transitions the UE 102 to an inactive state (e.g., the RRC_INACTIVE state, or RRC_IDLE state with a UE AS context stored) to suspend the radio connection. In some implementations, while the UE 102 communicates with the base station 104, the UE 102 determines or detects data inactivity and transmits 606 to the DU 174, UE assistance information (e.g., a UEAssistanceInformation message) indicating that the UE 102 prefers or requests to transition to the inactive state. In turn, the DU 174 transmits 608 a UL RRC Message Transfer message including the UE assistance information to the CU-CP 172A. Thus, the CU-CP 172A can determine that the UE 102 is in data inactivity based on the UE assistance information. In other implementations, the DU 174 can perform data inactivity monitoring for the UE 102. The CU-CP 172A can transmit a CU-to-DU message (e.g., a UE Context Setup Request message or a UE Context Modification Request message) to the DU 174 to request or command the DU 174 to perform the data inactivity monitoring. In cases where the DU 174 detects or determines that the UE 102 is in data inactivity during the monitoring, the DU 174 can transmit 610 an inactivity notification (e.g., (UE Inactivity Notification message) to the CU-CP 172A. Thus, the CU-CP 172A can determine that the UE 102 is in data inactivity based on the inactivity notification received from the DU 174. In yet other implementations, the CU-UP 172B can perform data inactivity monitoring for the UE 102. The CU-CP 172A can transmit a CP-to-UP message (e.g., a Bearer Context Setup Request message or a Bearer Context Modification Request message) to the CU-UP 172B to request or command the CU-UP 172B to perform the data inactivity monitoring. In cases where the CU-UP 172B detects or determines that the UE 102 is in data inactivity during the monitoring, the CU-UP 172B can transmit 612 an inactivity notification (e.g., Bearer Context Inactivity Notification message) to the CU-CP 172A. Thus, the CU-CP 172A can determine that the UE 102 is in data inactivity based on the inactivity notification received from the CU-UP 172B. In some implementations, the CU-CP 172A can determine that the UE 102 is in data inactivity based on the UE assistance information, inactivity notification of the event 610, and/or inactivity notification of the event 612.

After a certain period of data inactivity, the CU-CP 172A can determine that neither the CU 172 (i.e., the CU-CP 172A and/or the CU-UP 172B) nor the UE 102 has transmitted any data in the downlink direction or the uplink direction, respectively, during the certain period. In response to the determination, the CU-CP 172A can determine to transition the UE 102 to the inactive state.

In response to or after determining that the UE 102 is in data inactivity (for the certain period), the CU-CP 172A sends 616 to the CU-UP 172B a Bearer Context Modification Request message to suspend data transmission for the UE 102. In response, the CU-UP 172B suspends data transmission for the UE 102 and sends 618 a Bearer Context Modification Response message to the CU-CP 172A.

In response to determining to transition the UE 102 to the inactive state, the CU-CP 172A can generate an RRC release message (e.g., RRCRelease message or RRCConnectionRelease message) to transition the UE 102 to the inactive state. In some implementations, the CU-CP 172A may include a suspend configuration (e.g., SuspendConfig IE) in the RRC release message. The CU-CP 172A then sends 620 to the DU 174 a UE Context Release Command message which includes the RRC release message. In turn, the DU 174 transmits 622 the RRC release message to the UE 102. The RRC release message instructs the UE 102 to transition to the inactive state. The UE 102 transitions 624 to the inactive state from the connected state upon receiving the RRC release message. The UE 102 stores a UE access stratum (AS) context (e.g., UE Inactive AS context) in response to the RRC release message. The UE AS context includes configuration parameters, security key(s), and/or measurement configuration(s) that the UE 102 uses to communicate with the base station 104 before receiving the RRC release message. For example, the UE AS context configuration parameters may be included in the DU configuration. The CU-CP 172A also stores the UE AS context for the UE 102 operating in the inactive state. In some implementations, the RRC release message includes a periodic RAN notification area (RNA) timer value. The UE 102 starts a periodic RNA timer with the periodic RNA timer value after (e.g., in response to) receiving the RRC release message. In some implementations, the CU-CP 172A can start a network timer with a timer value, similar to the periodic RNA timer. Typically, the timer value of the network timer is larger than or equal to the periodic RNA timer value. In some implementations, if the CU-CP 172A connects the UE 102 before the network timer expires, the CU-CP 172A can restart or stop the network timer. If the network timer expires, the CU-CP 172A may determine that the UE 102 transitions to an idle state (e.g., the RRC_IDLE without a stored UE AS context) and releases the UE AS context. In some alternative implementations, the CU-CP 172A does not start or use the network timer and stores the UE AS context without time limit. In yet other implementations, the RRC release message does not include a periodic RNA timer value. In such implementations, the base station 104 does not start the network timer and stores the UE AS context without time limit.

In response to the UE Context Release Command message, the DU 174 can send a UE Context Release Complete message to the CU-CP 172A. In some implementations, the DU 174 releases a UE context of the UE 102 in response to the UE Context Release Command message. For example, the UE context includes configuration parameters and/or resources that the DU 174 configured for the UE 102 to communicate with the DU 174. In another example, the UE context includes transport layer configuration that the DU 174 configured for communicate data of the UE 102 with the CU-UP 172B. The transport layer configuration can include an IP address of the CU-UP 172B, a first tunnel ID (TEID) of the CU-UP 172B, and a second TEID of the DU 174.

In some alternative implementations, the CU-CP 172A can include the RRC release message in a DL RRC Message Transfer message instead of the UE Context Release Command message and transmits the DL RRC Message Transfer message to the DU 174. In turn, the DU 174 transmits the RRC release message to the UE 102 at event 622. In such cases, the CU-CP 172A still transmits a UE Context Release Command message not including an RRC release message to the DU 174, as described above.

In some implementations, the DU 174 establishes a connection with the NTN gateway to communicate data of the UE 102 in or before event 604. In such implementations, the DU 174 can perform a connection release procedure with a NTN gateway controlling the satellite 304 to release the connection, after receiving the UE Context Release Command message, transmitting the RRC release message to the UE 102, or receiving an acknowledgement for a PDU, including the RRC release message, that the DU 174 transmits to the UE 102. For example, the PDU is a MAC PDU and the acknowledgement is a hybrid automatic repeat request (HARQ) acknowledgement. In another example, the PDU is a RLC PDU and the acknowledgement is a RLC acknowledgement. In other implementations, when the DU 174 receives the UE Context Release Command message or transmits the RRC release message, the DU 174 performs the connection release procedure after a predetermined time.

In some scenarios or implementations, the UE 102 in the inactive state performs coverage detection (i.e., detecting whether the UE 102 is out of coverage). During the coverage detection, the UE 102 determines 626 out of coverage, e.g., because the satellite 304 moves away as described relative to FIG. 5. For example, the UE 102 is at the time instance t2 of FIG. 5 and the out of coverage continues in the period from t2 to t3. In some implementations, the UE 102 determines whether it is out of coverage by calculating the NTN coverage based on the ephemeris information of the serving and neighboring cells, and comparing the NTN coverage with the location where the UE 102 currently locates. In other implementations, the UE 102 determines whether it is out of coverage based on the time information regarding when the serving cell is going to stop serving the area (e.g., the t-Service-r17 value broadcasted in the NTN SIB), and whether UE is able to detect any cell prior to the time when the serving cell stops serving the area. The UE 102 in the inactive state refrains from or stops 628 initiating an RRC connection resume procedure while the UE is out of coverage detected in event 626. In some embodiments, the UE 102 can initiate an RRC connection resume procedure to transmit data (e.g., control-plane data or user-plane data), while operating in the inactive state. In another implementation, the UE 102 initiates an RRC connection resume procedure in response to expiry of the periodic RAN notification area (RNA) timer), while operating in the inactive state. That is, the UE initiates the RRC connection resume procedure for periodic RNA update. If the UE 102 in the inactive state has data to send or detects expiry of the periodic RNA timer, while the UE is out of coverage, the UE 102 refrains from initiating an RRC connection resume procedure. If the UE 102 in the inactive state has initiated an RRC connection resume procedure to transmit data or perform a periodic RNA update, and determines that the UE is out of coverage, the UE 102 stops (e.g., terminates) the RRC connection resume procedure.

In some further implementations, the UE 102 can determine whether the out of coverage is caused by discontinuous coverage (e.g., as described for FIG. 5). If the UE 102 determines that the out of coverage is caused by discontinuous coverage, the UE 102 refrains from or stops initiating an RRC connection resume procedure at event 628 as described above. Otherwise, if the UE 102 determines that the out of coverage is not caused by discontinuous coverage (e.g., temporarily out of coverage due to obstacle), the UE 102 can initiate an RRC connection resume procedure when the UE is back to the coverage. In other implementations, the UE 102 does not consider whether the out of coverage is caused by the discontinuous coverage.

Later in time, the UE 102 determines 630 that the UE 102 is in coverage, because the satellite 306 moves into the area where the UE stays. For example, the UE 102 is at the time instance t3 of FIG. 5 so that the UE 102 is in the coverage of the satellite 306. In some implementations, the UE 102 determines that the UE 102 is in the coverage based on the ephemeris information indicating the satellite 306 moves into the area where the UE 102 stays. In some implementations, the UE 102 received a system information block (SIB) including the ephemeris information from a base station (e.g., the base station 104 or 106) via a satellite (e.g., the satellite 304 or another satellite). For example, the SIB is SIB32. In another example, the SIB is SIB19. In other implementations, the UE 102 can be preconfigured with the ephemeris information in manufacturing. In yet other implementations, the UE 102 received the ephemeris information via a WiFi network or a terrestrial network. After determining that the UE 102 is in coverage, the UE 102 can initiate 632 an RRC connection resume procedure. In one implementation, the UE 102 can initiate the RRC connection resume procedure to transmit data (e.g., control-plane data or user-plane data). In another implementation, the UE 102 can initiate the RRC connection resume procedure to perform a periodic RNA update because the periodic RAN update timer expires while the UE is out of coverage.

In some implementations, if the UE 102 determines that the out of coverage determined at event 626 is caused by the discontinuous coverage, the UE 102 can deactivate AS function(s). If the UE 102 determines that the out of coverage is not caused by the discontinuous coverage, the UE 102 does not deactivate the AS function(s). In other implementations, the UE 102 deactivates the AS function(s) irrespective of whether the out of coverage is caused by the discontinuous coverage. The UE 102 can activate the AS function(s) while determining the UE is in coverage at event 630. When the UE 102 deactivates the AS function(s), the UE 102 can (continue to) maintain the periodic RNA timer running (if the UE 102 is configured to start the periodic RNA timer). That is, the AS function(s) does not include operating or running the periodic RNA timer. When the UE 102 deactivates the AS function(s), the UE 102 can (continue to) maintain the UE AS context. That is, the AS function(s) does not include maintaining or storing the UE AS context. More generally, in some implementations, the AS function(s) does not include function(s) related to the inactive state operation. If the AS function(s) include the function(s) related to the inactive station operation, the UE 102 will release the UE AS context and transition to the idle state. This will cause a long delay in transmitting data the next time when the UE 102 is back to the coverage and attempts to establish a connection, because the UE 102 has to perform several procedures as described above. In some implementations, the AS function(s) include a cell search function that searches one or more cells. In some implementations, the UE 102 can turn off a transceiver or cause the transceiver into a sleep mode or low power mode while the UE is out of coverage caused by the discontinuous coverage. In some implementations, the UE 102 can cause a cellular modem (e.g., baseband components such as a baseband processor) into a sleep mode or low power mode while the UE is out of coverage caused by the discontinuous coverage.

Referring next to FIG. 7A, an example scenario 700A in which the base station 104, includes a CU 172, a DU 174, a satellite 304 and a satellite 306, and the UE 102 detects radio link failure on a link with the satellite 304 while operating in a connected state with the base station 104. The differences between the scenarios 700A and 600 are discussed below.

In this scenario, the UE 102 initially operates in a connected state 702 and communicates 704 with the DU 174 via the satellite 304, e.g., by using a DU configuration, and communicates 704 with the CU-CP 172A and/or CU-UP 172B via the DU 174 and satellite 304, e.g., by using a CU configuration. Events 702 and 704 are similar to events 602 and 604.

While the UE 102 operates in the connected state with the base station 104 via the satellite 304, the UE 102 detects 706 radio link failure on the link with the satellite 304. To detect radio link failure, the UE 102 performs radio link monitoring on the link with the satellite 304. Before or after detecting 706 the radio link failure, the UE 102 determines 726 that the UE is out of coverage, similar to event 626. In some implementations, the UE 102 in the connected state refrains from 728 initiating an RRC connection reestablishment procedure while the UE is out of coverage detected in event 726. In other implementations, the UE 102 starts a timer (e.g., T311) and/or initiates a RRC connection reestablishment procedure, in response to the detection 706. In response to the determination 726, the UE 102 stops 728 the ongoing RRC connection reestablishment procedure and/or stops the timer. The UE 102 transitions 725 to an idle state (e.g., the RRC_IDLE without storing a UE AS context) in response to determining that the UE 102 is out of coverage at event 726. In some implementations, if the determination 726 occurs before the UE 102 detects radio link failure, the UE 102 can stop or suspend the radio link monitoring to refrain from detecting radio link failure or initiating a RRC connection reestablishment procedure. The UE 102 in the idle state refrains from 729 initiating an RRC connection establishment procedure while the UE 102 is out of coverage. In some implementations, the RRC connection reestablishment procedure and RRC connection establishment procedure are defined in 3GPP specification 38.331. In other implementations, the RRC connection reestablishment procedure and RRC connection establishment procedure are defined in 3GPP specification 36.331.

In some further implementations, the UE 102 can determine whether the out of coverage is caused by discontinuous coverage (e.g., as described for FIG. 5). If the UE 102 determines that the out of coverage is caused by discontinuous coverage, the UE 102 refrains from or stops (e.g., terminates) initiating an RRC connection reestablishment procedure at event 728 as described above. Otherwise, if the UE 102 determines that the out of coverage is not caused by discontinuous coverage, the UE 102 can initiate an RRC connection reestablishment procedure while out of coverage. In other implementations, the UE 102 does not consider whether the out of coverage is caused by the discontinuous coverage.

Later in time, the UE 102 determines 730 that the UE 102 is in coverage, similar to event 630. After determining that the UE 102 is in coverage, the UE 102 in the idle state can initiate 732 an RRC connection establishment procedure. In one implementation, the UE 102 can initiate the RRC connection establishment procedure to transmit data (e.g., control-plane data or user-plane data).

In some implementations, when the UE 102 determines that the out of coverage, determined at event 726 is caused by the discontinuous coverage, the UE 102 can deactivate AS function(s). If the UE 102 determines that the out of coverage is not caused by the discontinuous coverage, the UE 102 does not deactivate the AS function(s). In other implementations, the UE 102 deactivates the AS function(s) irrespective of whether the out of coverage is caused by the discontinuous coverage. The UE 102 can activate the AS function(s) while determining the UE 102 is in coverage at event 730. In some implementations, the AS function(s) include a cell search function that searches one or more cells. In some implementations, the UE 102 can turn off a transceiver or cause the transceiver to enter into a sleep mode or low power mode while the UE is out of coverage caused by the discontinuous coverage. In some implementations, the UE 102 can cause a cellular modem (e.g., baseband components such as a baseband processor) to enter into a sleep mode or low power mode while the UE 102 is out of coverage caused by the discontinuous coverage.

After the UE 102 encounters the radio link failure, the UE 102 and DU 174 do not communicate data anymore via the satellite 304 because the link between the UE 102 and base station 104 are broken. Thus, the DU 174 can detect data inactivity for the UE 102 and transmits 710 an inactivity notification to the CU-CP 172A, similar to event 610. After the UE 102 encounters the radio link failure, the UE 102 and CU-UP 172B do not communicate data anymore via the satellite 304 and DU 174 because the link between the UE 102 and base station 104 are broken. Thus, the CU-UP 172B can detect data inactivity for the UE 102 and transmit 712 an inactivity notification message to the CU-CP 172A, similar to event 612. After receiving the data inactivity notification message from the DU 174 or CU-UP 172B, the CU-CP 172A determines 714 to transition the UE 102 to suspend a radio connection with the UE 102, based on data inactivity of the UE, similar to event 614. In response to the determination, the CU-CP 172A can perform 716, 718 a Bearer Context Modification procedure with the CU-UP 172B, similar to events 616, 618. In response to the determination, the CU-CP 172A can transmit 720 a UE Context Release Command message to the DU 174 to command the DU 174 to release a UE context of the UE 102, similar to event 620.

In some implementations, the CU-CP 172A can include an RRC release message in the UE Context Release Command message or transmit a DL RRC Message Transfer message including the RRC release message to the DU 174 as described for event 620. Because of the radio link failure, the DU 174 fails to transmit the RRC release message to the UE 102. In some implementations, the DU 174 transmits an RRC Delivery Status to the CU-CP 172A to indicate that the DU 174 fails to transmit the RRC release message. In response to the indication, the CU-CP 172A transmits 736 a Bearer Context Release Command message to the CU-UP 172B to release a UE context of the UE 102 at the CU-UP 172B, instead of the Bearer Context Modification Request message. The UE context at the CU-UP 172B includes configuration parameters and/or resources that the CU-UP 172B configured for the UE 102. In another example, the UE context includes transport layer configuration that the CU-UP 172B configured for communicating data of the UE 102 with the DU 174 and a core network (e.g. SGW 112 or UPF 162). The transport layer configuration can include an IP address of the DU 174, an IP address of the core network, a first tunnel ID (TEID) of the CU-UP 172B, a second TEID of the DU 174, and a third TEID of the core network. In response to the Bearer Context Release Command message, the CU-UP 172B transmit 738 a Bearer Context Release Complete message to the CU-CP 172A.

Alternatively, after receiving the data inactivity notification message from the DU 174 or CU-UP 172B, the CU-CP 172A determines 714 to transition the UE 102 to the idle state (e.g., the RRC_IDLE without storing a UE AS context), based on data inactivity of the UE. In response to the determination, the CU-CP 172A transmits the Bearer Context Release Command message to the CU-UP 172B to release a UE context of the UE 102 at the CU-UP 172B at event 736, instead of the Bearer Context Modification Request message. In response to the Bearer Context Release Command message, the CU-UP 172B transmit the Bearer Context Release Complete message to the CU-CP 172A at event 738.

Referring next to FIG. 7B, a scenario 700B is generally similar to the scenario 700A. The differences between the scenarios 700B and 700A are discussed below.

The DU 174 detects 708 radio link failure on the link between the UE 102 and satellite 304. In some implementations, the DU 174 detects the radio link failure because the DU 174 has not received PDU(s) and/or control signal(s) from the UE 102 via the satellite 304 for a while. In response to detecting the radio link failure at event 708, the DU 174 transmits 710 the inactivity notification message to the CU-CP 172A, although the DU 174 has not detected data inactivity for the UE 102 yet. The inactivity notification message triggers the CU-CP 172A to determine that the UE 102 has data inactivity as described for FIG. 7A.

Referring next to FIG. 7C, a scenario 700C is generally similar to the scenarios 700A and 700B. The differences among the scenarios 700C and scenarios 700A and 700B are discussed below.

In response to detecting the radio link failure at event 708, the DU 174 transmits 709 a UE Context Release Request message to the CU-CP 172A. After (e.g., in response to) the UE Context Release Request message, the CU-CP 172A performs 736, 738 a UE Context Release procedure with the CU-UP 172B as described for FIG. 7A. In response to the IE Context Release Request message, the CU-CP 172A transmits 721 a UE Context Release Command message to the DU 174, similar to event 720 except that the CU-CP 172A may not include an RRC release message in the UE Context Release Command message. In this scenario, the CU-CP 172A may not transmit an RRC release message to the UE 102. In this scenario, the CU-CP 172A does not perform 716, 718 the Bearer Context Modification procedure with the CU-UP 172B. In some implementations, the CU-CP 172A determines not to transmit an RRC release message to the UE 102 or not to include an RRC release message in the IE Context Release Command message, based on or in response to the UE Context Release Request message.

In some implementations, the DU 174 can include a cause value indicating the radio link failure in the UE Context Release Request message. Thus, the CU-CP 172A determines that the radio link failure occurs on the link between the UE 102 and DU 174 based on the cause value. In some implementations, the CU-CP 172A determines not to transmit an RRC release message to the UE 102 or not to include an RRC release message in the IE Context Release Command message, based on the cause value.

Referring next to FIG. 8A, a scenario 800A is generally similar to the scenario 600. The differences between the scenario 800A and scenario 600 are discussed below.

While the UE 102 operates in the connected state with the base station 104 via the satellite 304, the UE 102 detects (e.g., determines) 805 that the satellite 304 is moving away from the UE 102, or the UE 102 is going to be out of NTN coverage soon. In response to the detection, the UE 102 can transmit 806 a UE assistance information message to the DU 174, which in turn transmits 808 a (I. RRC Message Transfer message including the UE assistance information message to the CU-CP 172A.

In some implementations, the UE 102 can indicate in the UE assistance information message that the satellite 304 is moving away from the UE 102, or the UE 102 is going to be out of NTN coverage soon. In one implementation, the UE 102 indicates a distance between the UE 102 and satellite 304 is above a threshold in the UE assistance information message. In one implementation, the UE 102 determines the threshold by itself. In another implementation, the threshold is preconfigured in the UE 102. In yet another implementation, the threshold is defined in a 3GPP specification. In yet another implementation, the UE 102 receives a message including the threshold from the base station 104. The message including the threshold can be a system information block broadcast by the base station via the satellite 304 or a dedicated message (e.g., RRC reconfiguration message) for the UE 102. In some implementations, the UE 102 can include a DL signal strength/quality of the satellite 304 in the UE assistance information message.

In another implementation, the UE 102 determines that the satellite 304 is moving away from the UE 102 only based on a DL signal strength/quality of the satellite 304. If the DL signal strength/quality is below a threshold, the UE 102 transmits the UE assistance information message at event 806. Otherwise, the UE 102 refrains from transmitting a UE assistance information message like event 806. The UE 102 can determine the threshold by itself or in accordance with a 3GPP specification, be pre-configured with the threshold, or receive the threshold in a broadcast message (e.g., SIB) or in a dedicated message (e.g., RRC reconfiguration message) from the base station 104 via the satellite 304. In such implementations, the UE 102 does not indicate or include a distance in the UE assistance information message. The UE 102 may not detect (e.g., track and/or check) the distance between the UE and satellite 304.

In other implementations, the UE 102 determines that the satellite 304 is moving away from the UE 102, based on the time information regarding when the serving cell is going to stop serving the area (e.g., the t-Service-r17 value broadcasted in the NTN SIB). In some implementations, the UE 102 determines it is going to be out of NTN coverage soon, based on the fact that the satellite 304 is moving away from the UE 102, and also based on the ephemeris information indicating there will be no upcoming satellite in the near future.

In some implementation, the UE 102 includes a time stamp of the detection 805 in the UE assistance information message. Based on the time instance or time stamp and the ephemeris information, the CU 172 determines when the UE 102 is out of coverage. In other implementations, the UE 102 includes a timer period (value) in the UE assistance information message, indicating that the UE 102 is out of coverage after the time period has elapsed. In one implementation, the UE 102 determines the time period (value) based on the ephemeris information. Based on the time period (value), the CU 172 determines when the UE 102 is out of coverage. In some implementations, the CU 172 accounts for propagation delay between the UE 102 and the DU 174 when determining when the UE 102 is out of coverage. For example, the CU 172 determines that the UE 102 is out of coverage after the time period has elapsed, minus the propagation delay. In other implementations, the UE 102 includes the propagation delay in the time period (value) between the UE 102 and the DU 174 when determining the time period (value). In yet other implementations, the UE 102 includes a time stamp indicating when the UE 102 is out of coverage in the UE assistance information message. The CU 172 determines when the UE 102 is out of coverage from the time stamp.

After (e.g., in response to) receiving the UE assistance information, the CU-CP 172A determines to transition the UE 102 to suspend a radio connection with the UE 102, similar to the description for event 614. Before the UE 102 in the connected state encounters radio link failure on the link with the satellite 304 as described in FIG. 7A, the CU-CP 172A can transition the UE 102 to the inactive state based on the determination.

In some alternative implementations, the UE 102 at events 806, 808 can transmit a measurement report message (e.g., MeasurementReport message) to the CU-CP 172A including the information included in the UE assistance information instead of transmitting the UE assistance information message. A benefit of using the UE assistance information message is that the UE 102 may not support transmitting a measurement report message.

The events 820, 822, 824, 826, 828, 830, and 832 are collectively referred to in FIG. 8A as a state transition and coverage detection procedure 890.

Referring next to FIG. 8B, a scenario 800B is generally similar to the scenarios 800A and 600, except that the CU-CP 172A transitions the UE 102 to the idle state instead of the inactive state. The CU-CP 172A configures the UE 102 to transition to the idle state in the RRC release message in FIG. 8B. For example, the CU-CP 172A does not include the suspend configuration in the RRC release message in FIG. 8B to indicate the UE 102 to transition to the idle state. Events 829 and 833 are similar to events 728 and 732, and the description for events 728 and 732 can apply to events 829 and 833. In some implementations, the UE 102 may indicate that it prefers to transition to the idle state in the UE assistance information message. Alternatively, the UE 102 still indicates that it prefers to transition to the inactive state in the UE assistance information message as described for FIG. 8A.

As the CU-CP 172A determines to transition the UE 102 to the idle state, the CU-CP 172A transmits 836 a Bearer Context Release Command message to the CU-UP 172B, similar to event 736. In response, the CU-CP 172B transmits 838 a Bearer Context Release Complete message to the CU-CP 172A, similar to event 738.

The events 820, 822, 825, 826, 829, 830, and 833 are collectively referred to in FIG. 8B as a state transition and coverage detection procedure 891.

In some alternative implementations, the CU-CP 172A can transition the UE 102 to the inactive state instead of the idle state, in response to the UE assistance information message, similar to the scenario 800D.

Referring next to FIG. 8C, a scenario 800C is generally similar to the scenarios 800A, 800B and 600, except that the DU 174 detects (e.g., determines) 807 that the satellite 304 is moving away from the UE 102 or the DU 174 and transmits 810 an inactivity notification message to the CU-CP 172A to in response to the detection. In this scenario, the UE 102 may not transmit to the CU-CP 172A a UE assistance information message described for FIG. 8A.

In some implementations, the DU 174 can detect that the satellite 304 is moving away from the UE 102 or DU 174 by detecting a distance between the DU 174 and satellite 304. If the DU 174 detects that the distance is above a threshold, the DU 174 transmits 810 the inactivity notification message to the CU-CP 172A. In one implementation, the DU 174 determines the threshold by itself. In another implementation, the threshold is preconfigured in the DU 174. In yet another implementation, the DU 174 receives the threshold from the CU-CP 172A.

In another implementation, the DU 174 determines that the satellite 304 is moving away from the UE 102 or DU 174 only based on a signal strength/quality of feeder link signal(s) from the satellite 304 to the DU 174. If the signal strength/quality is below a threshold, the DU 174 transmits the inactivity notification message at event 810. Otherwise, the DU 174 does not transmit an inactivity notification message like event 806. The DU 174 can determine the threshold by itself, be pre-configured with the threshold, or receive the threshold from the CU-CP 172A.

In yet another implementation, the DU 174 determines that the satellite 304 is moving away from the UE 102 or DU 174 based on a UL signal strength/quality from the UE 102 via the satellite 304. If the signal strength/quality is below a threshold, the DU 174 transmits the inactivity notification message at event 810. Otherwise, the DU 174 refrains from transmitting an inactivity notification message like event 806. The DU 174 can determine the threshold by itself, be pre-configured with the threshold, or receive the threshold from the CU-CP 172A.

In yet another implementation, the DU 174 determines that the satellite 304 is moving away from the UE 102 or DU 174 based on channel state information (CSI) received from the UE 102 via the satellite 304. The CSI can include a layer 1 reference signal received power (L1-RSRP) value. If the L1-RSRP value is below a threshold, the DU 174 transmits the inactivity notification message at event 810. Otherwise, the DU 174 refrains from transmitting an inactivity notification message like event 810. The DU 174 can determine the threshold by itself, be pre-configured with the threshold, or receive the threshold from the CU-CP 172A.

Referring next to FIG. 8D, a scenario 800D is generally similar to the scenarios 800A, 800B, 800C and 600, except that the DU 174 detects 807 that the satellite 304 is moving away from the UE 102 or the DU 174 and transmits 809 a UE Context Release Request message to the CU-CP 172A in response to the detection instead of an inactivity notification message, similar to event 709. In the procedure 890 or 891, the CU-CP 172A transmits the UE Context Release Command message to the DU 174 after (e.g., in response to) the UE Context Release Request message. Unlike event 709, the DU 174 does not include a cause indicating radio link failure in the UE Context Release Request message. Thus, the CU-CP 172A can transition the UE 102 to the inactive state or idle state after (e.g., in response to) receiving the UE Context Release Request message.

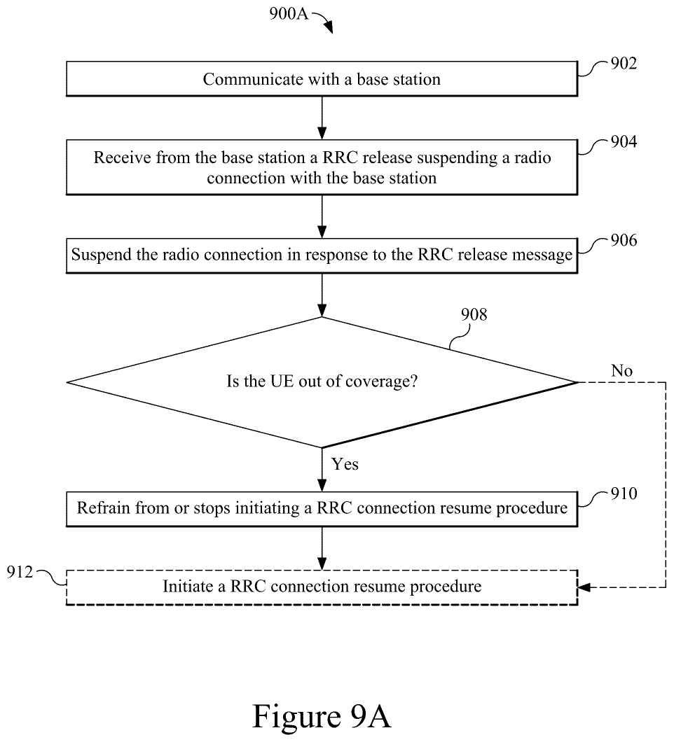

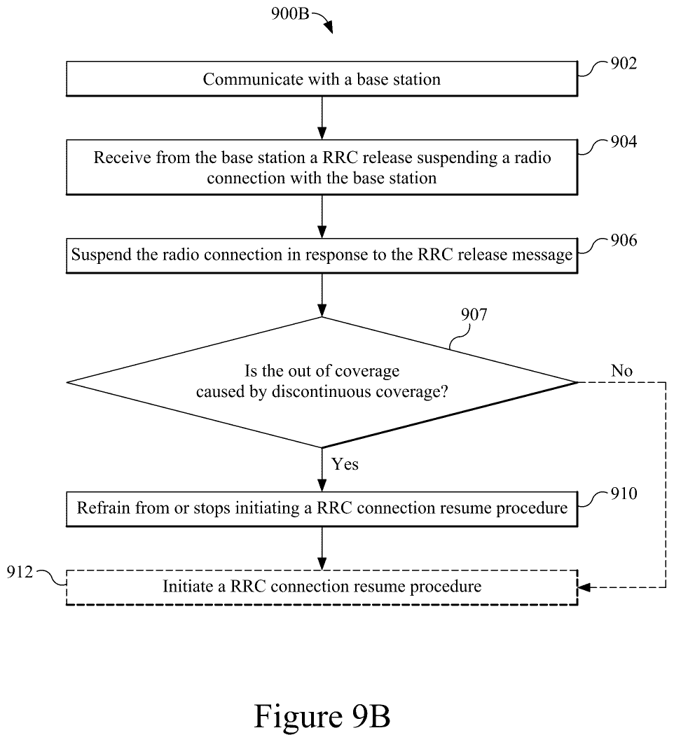

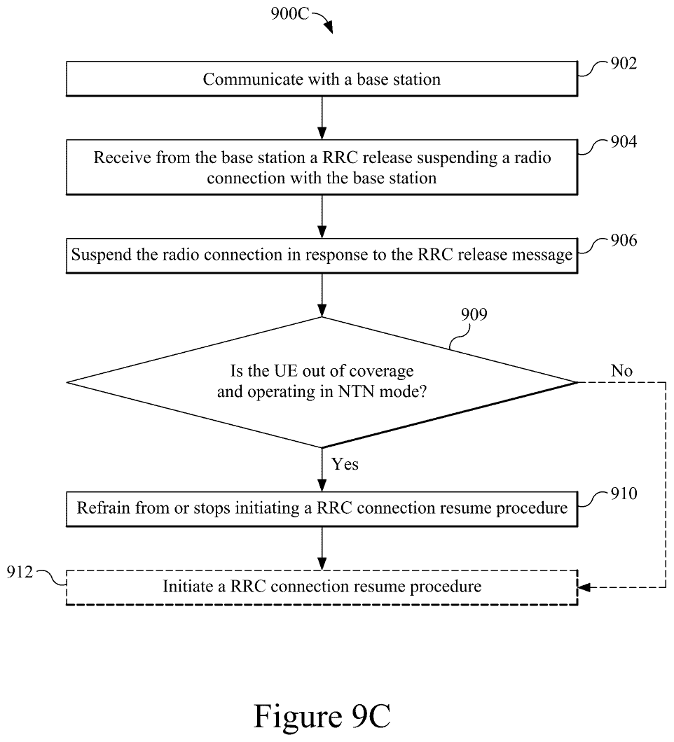

Next, several example methods that can be implemented in a UE (e.g., the UE 102) or a RAN node such as a base station (BS), a DU of a BS, or a CU of a BS are discussed with reference to FIGS. 9A-12. Each of these methods can be implemented using processing hardware such as one or more processors to execute instructions stored on a non-transitory computer-readable medium such as computer memory.

Referring first to FIG. 9A, a method 900A can be implemented in a UE (e.g., the UE 102) and includes determining whether to initiate an RRC connection resume procedure depending on whether the UE is in coverage or out of coverage.

The method 900A begins at block 902A, the UE communicates with a base station (e.g., events 604, 804). At block 904, the UE receives from the base station an RRC release message suspending a radio connection with the base station (e.g., events 622, 822, 890). At block 906, the UE suspends the radio connection in response to the RRC release message (e.g., events 624, 824, 890). At block 908, the UE determines whether the UE is out of coverage (e.g., events 626, 826, 630, 830, 890). If the UE determines that the UE is out of coverage at block 908, the flow proceeds to block 910. At block 910, the UE refrains from or stops initiating an RRC connection resume procedure (e.g., events 628, 828, 890). Otherwise, if the UE determines that the UE is in coverage at block 908, the flow proceeds to block 912. At block 912, the UE can initiate an RRC connection resume procedure (e.g., events 632, 832, 890).

FIG. 9B is a flow diagram of an example method 900B, similar to the method 900A, except that the method 900B includes block 907 instead of block 908.

At block 907, the UE determines whether the UE is out of coverage caused by discontinuous coverage (e.g., events 626, 826, 630, 830, 890). If the UE determines that the UE is out of coverage caused by discontinuous coverage at block 907, the flow proceeds to block 910. Otherwise, if the UE determines that the UE is in coverage or out of coverage not caused by discontinuous coverage at block 907, the flow proceeds to block 912.

FIG. 9C is a flow diagram of an example method 900C, similar to the method 900A, except that the method 900C includes block 909 instead of block 908.

At block 909, the UE determines whether the UE is out of coverage and in a NTN mode (e.g., events 626, 826, 630, 830, 890). If the UE determines that the UE is out of coverage and in a NTN mode at block 909, the flow proceeds to block 910. Otherwise, if the UE determines that the UE is in coverage or in a TN mode at block 909, the flow proceeds to block 912. In some scenarios or implementations, the UE in the TN mode can be in coverage or out of coverage.

In some implementations, while the UE operates in the NTN mode, the UE performs operation related to the NTN mode. In some implementations, while the UE operates in the TN mode, the UE performs operate related to the TN mode. In some implementations, NTN mode and TN mode can be NR NTN mode and NR TN mode, respectively. In other implementations, NTN mode and TN mode can be LTE NTN mode (e.g., LTE NB-IoT NTN mode) and LTE TN mode (e.g., LTE NB-IoT TN mode), respectively.

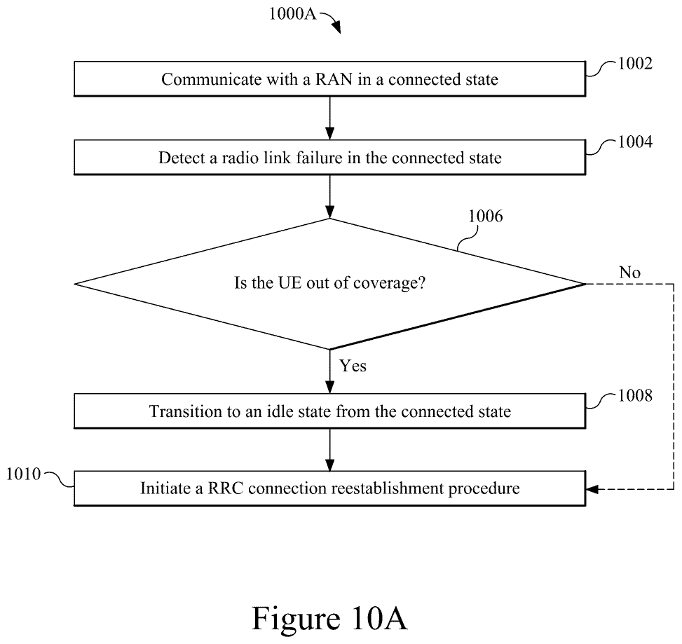

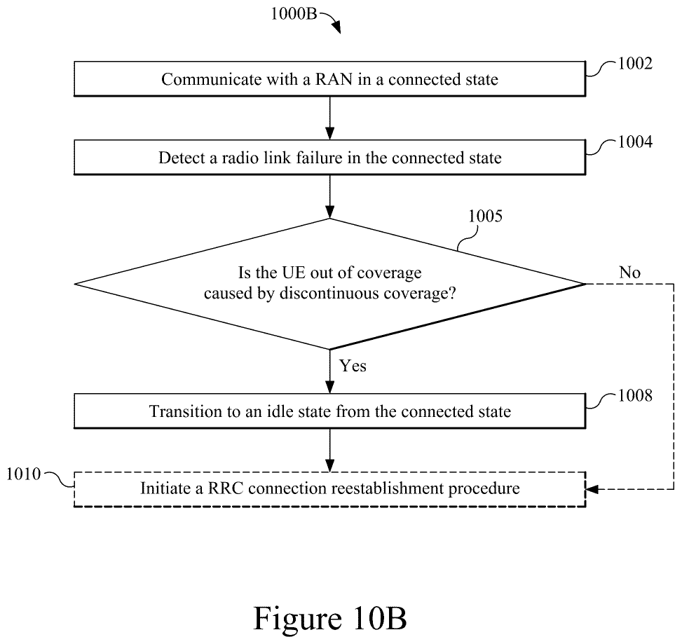

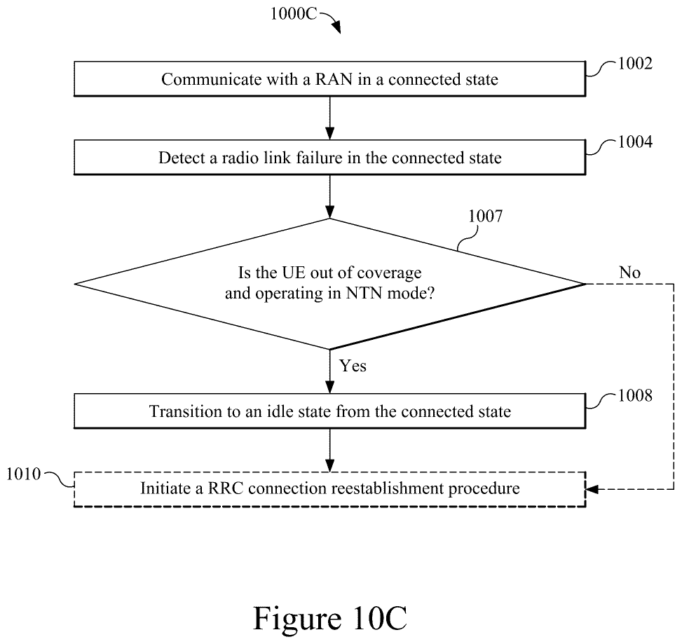

Referring now to FIG. 10A, a method 1000A can be implemented in a UE (e.g., the UE 102) and includes determining whether to initiate an RRC connection reestablishment procedure depending on whether the UE is in coverage or out of coverage.

The method 1000A begins at block 1002A, the UE communicates with a RAN in a connected state (e.g., event 704). At block 1004, the UE detects a radio link failure in the connected state (e.g., event 706). At block 1006, the UE determines whether the UE is out of coverage (e.g., events 726, 728). If the UE determines that the UE is out of coverage at block 1006, the flow proceeds to block 1008. At block 1008, the UE transitions to an idle state in response to detecting the radio link failure (e.g., event 725). Otherwise, if the UE determines that the UE is in coverage at block 1006, the flow proceeds to block 1010. At block 1010, the UE initiates an RRC connection reestablishment procedure in response to detecting the radio link failure.

In the RRC connection reestablishment procedure, the UE transmits an RRC reestablishment request message to the RAN, receives an RRC reestablishment message from the RAN in response to the RRC reestablishment request message and transmits an RRC reestablishment complete message to the RAN in response to the RRC reestablishment message. If the RAN operates LTE NB-IoT, the RRC reestablishment request message, RRC reestablishment message and RRC reestablishment complete message are RRCConnectionReestabishmentRequest-NB message, RRCConnectionReestabishment-NB message and RRCConnectionReestabishmentComplete-NB message, respectively. If the RAN operates NR, the RRC reestablishment request message, RRC reestablishment message and RRC reestablishment complete message are RRCReestabishmentRequest message, RRCReestabishment message and RRC ConnectionReestabishmentComplete message, respectively.

FIG. 10B is a flow diagram of an example method 1000B, similar to the method 1000A, except that the method 1000B includes block 1005 instead of block 1006.

At block 1005, the UE determines whether the UE is out of coverage caused by discontinuous coverage (e.g., events 726, 728). If the UE determines that the UE is out of coverage caused by discontinuous coverage at block 1005, the flow proceeds to block 1008. Otherwise if the UE determines that the UE is in coverage or out of coverage not caused by discontinuous coverage at block 1005, the flow proceeds to block 1010.

FIG. 10C is a flow diagram of an example method 1000C, similar to the method 1000A, except that the method 1000C includes block 1007 instead of block 1006.

At block 1007, the UE determines whether the UE is out of coverage and in a NTN mode (e.g., events 726, 728). If the UE determines that the UE is out of coverage and in a NTN mode at block 1007, the flow proceeds to block 1008. Otherwise, if the UE determines that the UE is in coverage or in a TN mode at block 1007, the flow proceeds to block 1010.

Examples and implementations described for FIG. 9C can apply to FIG. 10C.

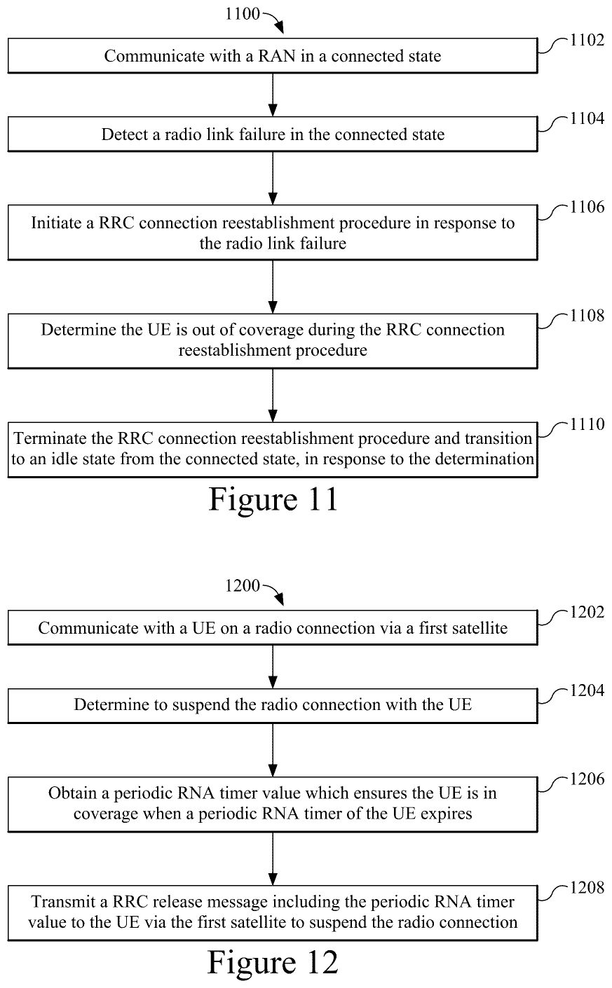

Referring now to FIG. 11, a method 1100 can be implemented in a UE (e.g., the UE 102) and includes terminating an RRC connection reestablishment procedure when the UE is out of coverage.

The method 1100 begins at block 1102, where the UE communicates with a RAN in a connected state (e.g., event 704). At block 1104, the UE detects a radio link failure in the connected state (e.g., event 706). At block 1106, the UE initiates an RRC connection reestablishment procedure in response to the radio link failure. At block 1108, the UE determines the UE is out of coverage during the RRC connection reestablishment procedure (e.g., event 726). At block 1110, the UE terminates the RRC connection reestablishment procedure and transitions to an idle state, in response to the determination (e.g., event 728).

In some implementations, the UE determines that the UE is out of coverage caused by discontinuous coverage at block 1108.

Referring next to FIG. 12, a method 1200 can be implemented in a RAN node (e.g., the base station 104 or CU-CP 172 of the base station 104) to configure a periodic RNA timer value. The method 1200 begins at block 1202, where the RAN node communicates with a UE on a radio connection via a first satellite (e.g., events 604, 804). In some implementations, the radio connection can include SRB(s) and DRB(s). At block 1204, the RAN node determines to suspend the radio connection with the UE (e.g., events 614, 814). At block 1206, the RAN node obtains a periodic RNA timer value which ensures the UE is in coverage when the periodic RNA timer of the UE expires. At block 1208, the RAN node transmits an RRC release message including the periodic RNA timer value to the UE via the first satellite to suspend the radio connection (e.g., events 620, 622, 820, 822, 890).

In some implementations, the RAN node at block 1206 determines the periodic RNA timer value based on a time when the UE will be within the coverage, which is determined based on the ephemeris information of a second satellite (e.g., the satellite 306) and other information (e.g., a geographic area or a GNSS coordinate of the UE). In some implementations, the RAN node is preconfigured with the periodic RNA timer value that is determined offline based on the ephemeris information and other information (e.g., a fixed geographic area or a fixed geographic coordinate of a stationary UE). In other implementations, the RAN node determines the periodic RNA timer value only based the ephemeris information of a second satellite (e.g., the satellite 306), if the second satellite provides a quasi-earth-fixed cell that is able to cover the entire cell provided by the first satellite.

The following description may be applied to the description above.

Generally speaking, description for one of the above figures can apply to another of the above figures. Examples, implementations and methods described above can be combined, if there is no conflict. An event or block described above can be optional or omitted. For example, an event or block with dashed lines in the figures can be optional. In some implementations, “message” is used and can be replaced by “information element (IE)”, and vice versa. In some implementations, “IE” is used and can be replaced by “field”, and vice versa. In some implementations, “configuration” can be replaced by “configurations” or “configuration parameters”, and vice versa.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software may be executed by one or more general-purpose processors or one or more special-purpose processors.

1-15. (canceled)

16. A wireless communication method performed by a user equipment, UE, configured to communicate with a non-terrestrial network, NTN, the method comprising:
detecting radio link failure (RLF);
determining whether the RLF is due to the UE being out of a serving satellite coverage and whether the UE is in a discontinuous coverage area; and
selectively transitioning the UE to an idle state based on the determining.

17. The wireless communication method of claim 16, further comprising one of:
initiating a radio resource connection, RRC, reestablishment procedure when the UE is not out of the serving satellite coverage and the UE is not in the discontinuous coverage area; or
transitioning to the idle state when the RLF is due to the UE being out of the serving coverage satellite and when the UE is in the discontinuous coverage area.

18. The wireless communication of claim 16, further comprising one of:
transitioning to the idle state when the RLF is due to the UE being out of the serving coverage satellite; or
transitioning to the idle state when the UE is in the discontinuous coverage area.

19. The wireless communication method of claim 16, further comprising starting a timer in response to the determining.

20. The wireless communication method of claim 19, further comprising starting a new timer after a time interval of the timer.

21. The wireless communication method of claim 19, further comprising initiating an RRC reestablishment procedure when a time interval corresponding to the timer expires.

22. The wireless communication method of claim 16, further comprising refraining from initiating an RRC reestablishment procedure while in the idle state.

23. The wireless communication method of claim 16, further comprising:
determining, after the selective transitioning the UE to the idle state, that the UE is in NTN coverage and initiating an RRC reestablishment procedure.

24. The wireless communication method of claim 16, further comprising:
determining a time period while the UE is out of the serving satellite coverage and deactivating Access Stratum (AS) functions during the time period.

25. The wireless communication method of claim 16, further comprising:
deactivating AS functions when the UE determines the UE is in the discontinuous coverage area.

26. The wireless communication method of claim 16, wherein the UE enters a sleep mode or low power mode when the UE determines the UE is in the discontinuous coverage area.

27. A user equipment, UE, configured to communicate with a non-terrestrial network, NTN, the UE comprising:
a transceiver configured to detect radio link failure (RLF);
a processor to perform a calculation to determine whether the RLF is due to the UE being out of a serving satellite coverage and whether the UE is in a discontinuous coverage area; and
a computer-readable storage media storing executable instructions for the processor,
wherein the processor is configured to selectively transition the UE to an idle state based on the calculation.

28. The UE of claim 27, wherein the processor is configured to one of:
initiate a radio resource connection, RRC, reestablishment procedure when the UE is not out of the serving satellite coverage and the UE is not in the discontinuous coverage area; or
transition to the idle state when the RLF is due to the UE being out of the serving coverage satellite and when the UE is in the discontinuous coverage area.

29. The UE of claim 27, wherein the processor is configured to one of:
transition to the idle state when the RLF is due to the UE being out of the serving coverage satellite; or
transition to the idle state when the UE is in the discontinuous coverage area.

30. The UE of claim 27, wherein the processor is configured to start a timer in response to the calculation.

31. The UE of claim 30, wherein the processor is configured to start a new timer after a time interval of the timer.

32. The UE of claim 30, wherein the processor is configured to initiate an RRC reestablishment procedure when a time interval corresponding to the timer expires.

33. The UE of claim 27, wherein in the idle state the processor is configured to refrain from initiating an RRC reestablishment procedure.

34. The UE of claim 27, wherein the processor is configured to determine, after the selective transitioning the UE to the idle state, that the UE is in NTN coverage and initiate an RRC reestablishment procedure.

35. The UE of claim 27, wherein the processor is configured to determine a time period while the UE is out of the serving satellite coverage and control the transceiver to deactivate Access Stratum (AS) functions during the time period.

36. The UE of claim 27, wherein the processor is configured to control the transceiver to deactivate AS functions when the UE determines the UE is in the discontinuous coverage area.

37. The UE of claim 27, wherein the processor is configured to cause the UE to enter a sleep mode or low power mode when the UE determines the UE is in the discontinuous coverage area.
